(19) United States
(12) Patent Application Publication
(10) Pub. No.: US 2026/0301696 A1
(43) Pub. Date: Oct. 1, 2026

(54) DISPLAY DEVICE

(71) Applicant: LG Display Co., Ltd., Seoul (KR)

(72) Inventors: Jeonghyo PARK, Paju-si (KR); Mookyoung HONG, Paju-si (KR)

(73) Assignee: LG Display Co., Ltd., Seoul (KR)

(21) Appl. No.: 19/632,932

(22) Filed: Mar. 30, 2026

(30) Foreign Application Priority Data
Mar. 31, 2025 (KR) 10-2025-0041278

(51) Int. Cl. G09G 3/3291; G09G 3/32

(52) U.S. Cl. CPC G09G 3/3291; G09G 3/32; G09G 2310/0275; G09G 2310/0294; G09G 2320/0233; G09G 2330/022; G09G 2330/027

(57) ABSTRACT

A display device includes a pixel connected to a data line and a sensing line; and a display driver for supplying a data voltage to the data line and receiving a sensing signal from the sensing line. The display driver may include a first switch to supply a reference voltage to the sensing line; a second switch to supply a low-potential voltage to the sensing line; a sampling-holding module including a third switch connected to the sensing line, an analog-to-digital converter connected to the third switch and outputting sensing data, and a holding capacitor to hold a voltage applied to the analog-to-digital converter; a fourth switch to supply the low-potential voltage to the analog-to-digital converter; and a fifth switch to supply a sensing reference voltage to the analog-to-digital converter, the sensing reference voltage setting the range of the reference voltage during the sensing process of the reference voltage.

### CROSS-REFERENCE TO RELATED APPLICATIONS

This application claims the benefit of and priority to Korean Patent Application No. 10-2025-0041278 filed on Mar. 31, 2025, the entire contents of which are incorporated herein by reference for all purposes.

### BACKGROUND

### 1. Technical Field

Example embodiments of the present disclosure relate to a display device.

### 2. Description of Related Art

As the information society develops, various simplify demands for display devices that display images are increasing and various types of display devices, such as liquid crystal displays and organic light emitting diode displays, are being used.

The image displayed on the display device may be a still image or a moving image, and in the case of a moving image, it may be of various types such as a sports image, a game image, a movie, etc. The display device may include a plurality of pixels and a plurality of switching elements for driving the pixels.

The description of related art should not be considered prior art merely because it is mentioned in or associated with this section. The description of related art includes information that describes one or more aspects of the subject technology, and the description in this section does not limit the scope of the present disclosure.

### SUMMARY

One or more aspects of the present disclosure solve one or more problems due to limitations and disadvantages of the related art, and example embodiments of the present disclosure may provide a display device that may compensate for deviation in a power voltage to correct the sensing data and prevent the occurrence of brightness deviation even if the control circuit board is replaced after the manufacturer's shipment or as a part of product repair.

Aspects according to the present disclosure are not limited to the above ones, and other aspects and advantages that are not mentioned above may be clearly understood from the following description and may be more clearly understood from the example embodiments set forth herein.

To address these and other advantages and aspects of the present disclosure, a display device according to one or more example embodiments of the present disclosure may include a display panel comprising a pixel, the pixel having a light-emitting element configured to emit light, the pixel connected to a data line and a sensing line; and a display driver configured to supply a data voltage to the data line and receive a sensing signal from the sensing line, and the display driver may include a first switch configured to supply a reference voltage to the sensing line; a second switch configured to supply a low-potential voltage to the sensing line; a sampling-holding module comprising a third switch connected to the sensing line, an analog-to-digital converter connected to the third switch and outputting sensing data, and a holding capacitor configured to hold a voltage applied to an input terminal of the analog-to-digital converter; a fourth switch configured to supply the low-potential voltage to the analog-to-digital converter; and a fifth switch configured to supply a sensing reference voltage to the analog-to-digital converter, the sensing reference voltage setting the range of the reference voltage during the sensing process of the reference voltage.

In another aspect, a display device according to one or more example embodiments may include a display panel comprising a pixel, the pixel having a light-emitting element configured to emit light, the pixel connected to a data line and a sensing line; a display driver including a sampling-holding module, the sampling-holding module configured to supply a data voltage to the data line and receive a sensing signal from the sensing line; a source circuit board electrically connected to the display driver; a memory mounted on the source circuit board; a control circuit board electrically connected to the source circuit board; and a timing controller mounted on the control circuit board, the timing controller configured to control a driving timing of the display driver, and the display driver may include an output channel connected to the data line; a sensing channel connected to the sensing line; and a plurality of dummy channels configured to receive an offset voltage for adjusting the gain of the analog-to-digital converter, a source driving voltage driving the display driver, and the reference voltage.

Specific descriptions of other example embodiments are provided in detailed description and the accompanying drawings.

According to one or more example embodiments of the present disclosure, the display device may correct the reference voltage, source drive voltage, and offset voltage using the sensing reference voltage after performing a process of correcting the sensing reference voltage, thereby correcting the deviation of the power supply voltage and correcting the sensing data and preventing the occurrence of brightness deviation even if the control circuit board is replaced after shipment from the manufacturer or as a part of product repair.

The display device according to one or more example embodiments of the present disclosure may optimize the driving system and reduce power consumption by improving the distribution of the control circuit board.

In addition to the above-described effects, specific effects of the present disclosure will be described together with the following detailed description for implementing the present disclosure.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further features, advantages, and aspects are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is a plan view illustrating a display device according to one example embodiment;

FIG. 2 is a plan view illustrating a display device with a setting control circuit board connected during the manufacturing process of the display device according to one example embodiment;

FIG. 3 is a block diagram illustrating a display device according to one example embodiment;

FIG. 4 is a diagram illustrating a display driver and pixels of a display device according to one example embodiment;

FIG. 5 is a timing diagram illustrating signals and voltages during an RT period of a display device according to one example embodiment;

FIG. 6 is a timing diagram illustrating signals and voltages during an OFF-RS period of a display device according to one example embodiment;

FIG. 7 is a flowchart illustrating a process for correcting a first reference voltage in a power-on state of a display device according to one example embodiment;

FIG. 8 is a flowchart illustrating a process for correcting a first reference voltage in a power-off state of a display device according to one example embodiment;

FIG. 9 is a flowchart illustrating a process for correcting a first source driving voltage in a power-on state of a display device according to one example embodiment;

FIG. 10 is a flowchart illustrating a process for correcting a first source driving voltage in a power-off state of a display device according to one example embodiment;

FIG. 11 is a flowchart illustrating a process for correcting a sensing reference voltage of a display device according to one example embodiment;

FIG. 12 is a diagram illustrating first to third display drivers of a display device according to one example embodiment;

FIG. 13 is a diagram illustrating first to third display drivers of a display device according to another example embodiment;

FIG. 14 is a block diagram illustrating a driving module and a sensing module of a display driver in a display device according to one example embodiment;

FIG. 15 is a waveform diagram illustrating voltages and signals applied to a display device according to one example embodiment; and

FIG. 16 is a diagram illustrating a configuration of a data voltage of a display device according to one example embodiment.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Reference is now made in detail to embodiments of the present disclosure, examples of which may be illustrated in the accompanying drawings. In the following description, when a detailed description of well-known methods, functions, structures or configurations may unnecessarily obscure aspects of the present disclosure, the detailed description thereof may have been omitted for brevity. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, widths, heights, thicknesses, locations, radii, diameters, and areas), proportions, ratios, angles, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., layers, films, components, electrodes, structures, transistors, sections, members, parts, regions, areas, portions, steps, operations, and/or the like), one or more other elements may be added unless a term such as “only” or the like is used. The terms used in the present disclosure are merely used in order to describe particular example embodiments, and are not intended to limit the scope of the present disclosure. Any references to singular may include plural, and vice versa, unless expressly stated otherwise. In one or more examples, unless expressly stated otherwise, an element may be one or more elements; and an element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., layers, films, components, electrodes, structures, transistors, sections, members, parts, regions, areas, portions, and/or the like) are described using any of the terms such as “on,” “over,” “under,” “above,” “upper,” “below,” “beneath,” “near,” “close to,” “adjacent to,” “beside,” “next to,” “at or on a side of,” and/or the like indicating a position or location, one or more other elements may be located between the two elements unless a more limiting term, such as “immediate(ly),” “direct(ly),” or “close(ly),” is used. For example, when an element and another element are described using any of the foregoing terms, this description should be construed as including a case in which the elements contact each other directly as well as a case in which one or more additional elements are disposed or interposed therebetween. Furthermore, the spatially relative terms such as the foregoing terms as well as other terms such as “front,” “rear,” “back,” “left,” “right,” “top,” “bottom,” “upper,” “lower,” “downward,” “upward,” “up,” “down,” “column,” “row,” “vertical,” “horizontal,” “diagonal,” and the like refer to an arbitrary frame of reference. For example, these terms may be used for an example understanding of a relative relationship between elements, including any correlation as shown in the drawings. However, embodiments of the disclosure are not limited thereby or thereto. The spatially relative terms are to be understood as terms including different orientations of the elements in use or in operation in addition to the orientation depicted in the drawings or described herein. For example, where a lower element or an element positioned under another element is overturned, then the element may be termed as an upper element or an element positioned above another element. Thus, for example, the term “under” or “beneath” may encompass, in meaning, the term “above” or “over.” An example term “below” or the like, can include all directions, including directions of “below,” “above” and diagonal directions. Likewise, an example term “above,” “on” or the like can include all directions, including directions of “above,” “on,” “below” and diagonal directions.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., layers, films, components, electrodes, structures, transistors, sections, members, parts, regions, areas, portions, steps, operations, and/or the like), these elements should not be limited by these terms, for example, to any particular order, precedence, or number of elements. Further, these are not used to define the essence or basis of the elements. These terms are merely used to refer to one element separately from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

The expression that an element (e.g., layer, film, component, electrode, structure, transistor, section, member, part, region, area, portion, or the like) “is engaged” with another element may be understood, for example, as that the element may be either directly or indirectly engaged with the another element. The term “is engaged” or similar expressions may refer to a term such as “is in contact,” “contacts,” “overlaps,” “crosses,” “intersects,” “is connected,” “is coupled,” “is attached,” “is combined,” “is linked,” “is provided,” “is disposed,” “interacts,” or the like. The engagement may involve one or more intervening elements disposed or interposed between the element and the another element, unless otherwise specified. Further, the element may be engaged at least partially or entirely (or completely) with the another element, unless otherwise specified. Further, the element may be included in at least one of two or more elements that are engaged with each other. Similarly, the another element may be included in at least one of two or more elements that are engaged with each other. When the element is engaged with the another element, at least a portion of the element may be engaged with at least a portion of the another element. The term “with another element” or similar expressions may be understood as “another element,” or “with, to, in, or on another element,” as appropriate by the context. Similarly, the term “with each other” may be understood as “each other,” or “with, to, or on each other,” as appropriate by the context.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally. For example, the terms “first direction,” “second direction,” and the like should not be interpreted only based on a geometrical relationship in which the respective directions are parallel, perpendicular, diagonal, or slanted with respect to each other, and may be meant as directions having wider directivities within the range within which the components of the present disclosure may operate functionally.

The term “at least one” should be understood as including any and all combinations of one or more of the associated listed items. For example, unless stated otherwise, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, unless stated otherwise, at least one of a plurality of elements can represent (i) one element of the plurality of elements, (ii) some elements of the plurality of elements, or (iii) all elements of the plurality of elements. Further, unless stated otherwise, “at least some,” “some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) one or more elements of the plurality of elements, (v) multiple elements of the plurality of elements, or (vi) all of the plurality of elements. Moreover, unless stated otherwise, “at least some,” “some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, (iii) the element, or (iv) all portions of the element.

The expression of a first element, a second elements “and/or” a third element should be understood as any one of the first, second and third elements or as any or all combinations of the first, second and third elements. Similar interpretations apply to the use of “and/or” with two elements or with more than three elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise. In one or more aspects, unless stated otherwise, the term “nth” may refer to “nnd” (e.g., 2nd where n is 2), or “nrd” (e.g., 3rd where n is 3), and n may be a natural number or a whole number.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” or “nearly the same” may indicate a degree of being considered as being equivalent to each other taking into account minute differences due to errors in the manufacturing process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein. For example, unless stated otherwise, the term “part,” “unit,” or “module” may refer to, for example, a circuit, a component, an integrated circuit, a computational block of a circuit device, or a structure configured to perform a described function, as would be understood by one of ordinary skill in the art.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same or similar elements may be illustrated in other drawings, and like reference numerals may refer to like or similar elements unless stated otherwise. The same or similar elements may be denoted by the same reference numerals even if they are depicted in different drawings. Unless otherwise stated, repetitive descriptions of the same or similar elements may be omitted for brevity, and elements designated by the same or similar reference numerals in different figures have the same descriptions. In addition, for the convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

In description of flow of a signal, for example, when a signal is provided (e.g., supplied, received, transferred or transmitted) from a node A to a node B, this may include a case where the signal is provided from the node A to the node B via one or more nodes unless a phrase such as “immediately provided,” “directly provided” or the like is used.

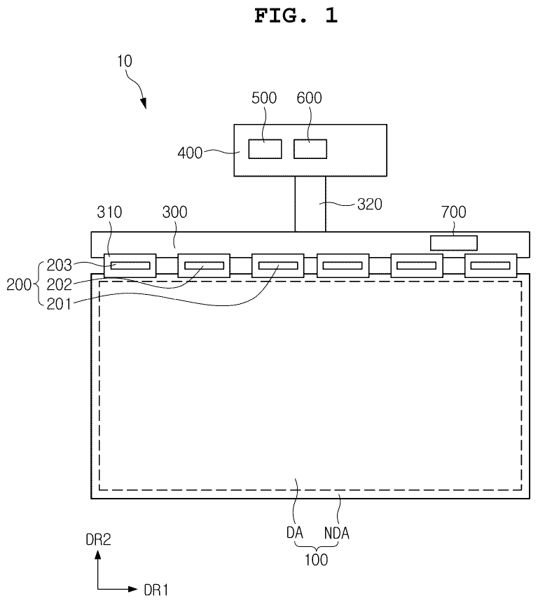

FIG. 1 is a plan view illustrating a display device according to one example embodiment.

Referring to FIG. 1, the display device 10 may be included in one or more portable electronic devices, such as mobile phones, smart phones, tablet personal computers (PCs), mobile communication terminals, electronic notebooks, electronic books, portable multimedia players (PMPs), navigation systems, and ultra-mobile PCs (UMPCs). For example, the display device 10 may be included as a display unit for a television, laptop, monitor, billboard, or Internet of Things (IoT). As another example, the display device 10 may be included in one or more wearable devices, such as smart watches, watch phones, eyeglass displays, and head-mounted displays (HMDs).

The display device 10 may include a display panel 100, a display driver 200, a source circuit board 300, a flexible film 310, a flexible cable 320, a control circuit board 400, a timing controller 500, a power supply unit 600, and a memory 700.

The display panel 100 may include a display area (DA) and a non-display area (NDA). The display area (DA) may include a plurality of pixels that display an image. Each of the plurality of pixels may emit light from a light-emitting area or an aperture area. For example, the display area (DA) may include a pixel circuit including switching elements, a pixel definition film defining a light-emitting area, and a self-light emitting element.

For example, the self-luminous element may include at least one of an organic light emitting diode (OLED) including an organic light emitting layer, a quantum dot LED including a quantum dot light emitting layer, an inorganic LED including an inorganic semiconductor, and an ultra-small light emitting diode (micro LED or nano LED), but is not limited thereto.

The display driver 200 may supply a data voltage to the data line of the display panel 100. The display driver 200 may be electrically connected to the data line of the display panel 100 through the flexible film 310 and the pad portion of the display panel 100. The display driver 200 may be formed as an integrated circuit (IC). For example, the display driver 200 may be mounted on one surface of the flexible film 310 using a COF (Chip on Film) method. The flexible film 310 may include lines electrically connecting the display driver 200 and the display panel 100. One side of the flexible film 310 may be electrically connected to a pad portion of the display panel 100, and the other side of the flexible film 310 may be electrically connected to the source circuit board 300.

The display driver 200 may include first to third display drivers 201, 202, 203. In FIG. 1, the display driver 200 may include the first to third display drivers 201, 202, 203, but the number of display drivers 200 is not limited thereto. For another example, the display driver 200 may further include at least one display driver 200 adjacent to the third display driver 203.

Each of the first to third display drivers 201, 202, 203 may include an output channel, a sensing channel, and a dummy channel. For example, the dummy channels of each of the first to third display drivers 201, 202, and 203 may receive substantially the same voltage and signal. For another example, the dummy channels of each of the first to third display drivers 201, 202, and 203 may receive different voltages and signals.

The first display driver 201 may be arranged closest to the control circuit board 400 or the flexible cable 320. If the flexible cable 320 is arranged at the center of the source circuit board 300 or the control circuit board 400, the first display driver 201 may be arranged adjacent to the center of the display area (DA).

The second display driver 202 may be arranged adjacent to the first display driver 201. The second display driver 202 may not be closer to the control circuit board 400 or the flexible cable 320 than the first display driver 201, and may be arranged relatively closer to the control circuit board 400 or the flexible cable 320 than the third display driver 203.

The third display driver 203 may be arranged adjacent to the second display driver 202. The third display driver 203 may be furthest from the control circuit board 400 or the flexible cable 320 among the first to third display drivers 201, 202, 203.

The source circuit board 300 may be a printed circuit board (PCB) on which a memory 700 is mounted. For example, the source circuit board 300 may have an NSP (NAND on Source PCB) structure. The source circuit board 300 may electrically connect the control circuit board 400 and the flexible film 310. The source circuit board 300 may be a printed circuit board including lines electrically connecting the display driver 200 and other devices. The source circuit board 300 may be electrically connected to the control circuit board 400 via a flexible cable 320. For example, the flexible cable 320 may be a flexible flat cable (FFC), but is not limited thereto.

The control circuit board 400 may be a printed circuit board on which a timing controller 500 and a power supply unit 600 are mounted. Without being limited to the illustration in FIG. 1, the control circuit board 400 may mount control components and various electrical devices.

The timing controller 500 may be attached to one surface of the control circuit board 400. The timing controller 500 may transmit digital video data to the display driver 200 to control the driving timing of the display driver 200.

The power supply unit 600 may generate a power voltage and supply it to the display panel 100 or the display driver 200. Here, the power voltage may include, but is not limited to, one or more of a driving voltage (VDD), a low-potential voltage (VSS), an initialization voltage (Vint), a reference voltage (VREF), a bias voltage (Vbias), a source driving voltage (SVDD), a sensing reference voltage (EVRF), and an offset voltage (VRTA).

The memory 700 may store sensing information of pixels. For example, the memory 700 may store threshold voltage information of a transistor received from the display driver 200 and supply the threshold voltage information to the timing controller 500. The memory 700 may store the reference voltage (VREF) and the source driving voltage (SVDD) sensed by the manufacturer of the display panel 100.

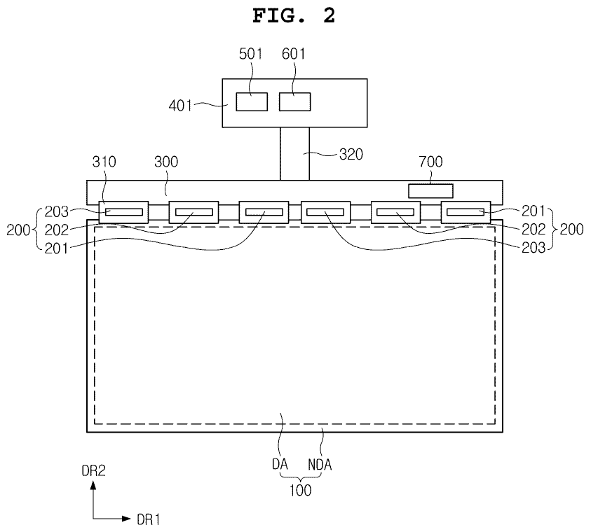

FIG. 2 is a plan view showing a display device connected to a setting control circuit board during a manufacturing process of the display device according to one example embodiment. Here, the setting control circuit board 401, the setting timing controller 501, and the setting power supply unit 601 may be used by the manufacturer to set the default values of the display panel 100 and the display driver 200. Hereinafter, the first reference voltage and the first source driving voltage may correspond to the reference voltage (VREF) and the source driving voltage (SVDD) used for driving the display device 10, respectively. The second reference voltage and the second source driving voltage may correspond to the reference voltage (VREF) and the source driving voltage (SVDD) used for setting the default values by the manufacturer of the display panel 100, respectively. The reference voltage (VREF) may be used in the sensing process of the driving transistor or the anode electrode of the pixel (SP), and the source driving voltage (SVDD) may correspond to the total voltage required for driving the display driver 200.

Referring to FIGS. 1 and 2, the source circuit board 300 may be manufactured by the same manufacturer as the display panel 100 and delivered to the customer. The source circuit board 300 may be electrically connected to a setting control circuit board 401, a setting timing controller 501, and a setting power supply unit 601 by the manufacturer. The setting power supply unit 601 may output a second reference voltage, and the display driver 200 may sense the second reference voltage. The memory 700 may be delivered to the customer in a state in which the second reference voltage is stored.

The setting power supply unit 601 may output a second source driving voltage, and the display driver 200 may sense the second source driving voltage. The memory 700 may be delivered to the customer in a state in which the second source driving voltage is stored.

The source circuit board 300 may be electrically connected to the control circuit board 400, the timing controller 500, and the power supply unit 600 at the customer site. The power supply unit 600 may output a first reference voltage, and the display driver 200 may sense the first reference voltage. The timing controller 500 may compare the first and second reference voltages to calculate an error value, calculate a correction value, and transmit the calculated correction value to the power supply unit 600. The display driver 200 may be driven by receiving the corrected first reference voltage from the power supply unit 600.

The power supply unit 600 may output a first source driving voltage, and the display driver 200 may sense the first source driving voltage. The timing controller 500 may compare the first and second source driving voltages to calculate an error value, calculate a correction value, and transmit the calculated correction value to the power supply unit 600. The display driver 200 may be driven by receiving the corrected first source driving voltage from the power supply unit 600.

For another example, the setting control circuit board 401, the setting timing controller 501, and the setting power supply unit 601 may be used by the customer before the display device 10 is repaired or parts are replaced. In this case, the control circuit board 400, the timing controller 500, and the power supply unit 600 may be used after the display device 10 is repaired or parts are replaced. Therefore, the reference voltage (VREF), the source driving voltage (SVDD), and the sensing reference voltage (EVRF) may be additionally corrected even after the control circuit board 400, the timing controller 500, and the power supply unit 600 are replaced.

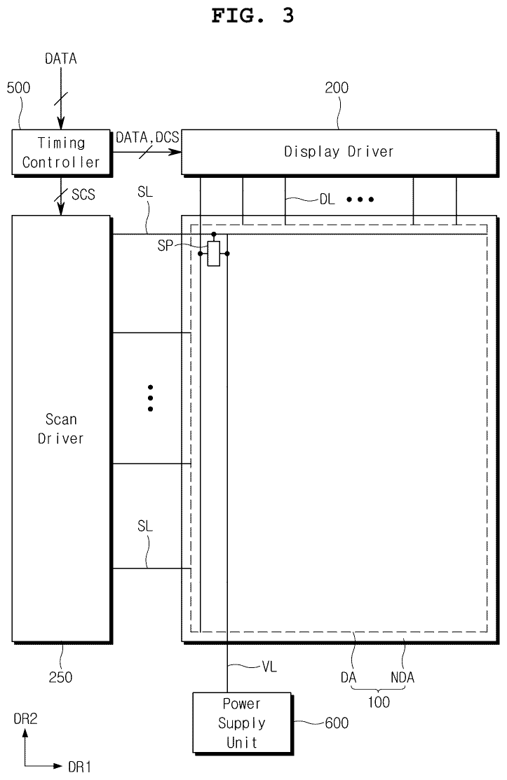

FIG. 3 is a block diagram illustrating a display device according to one example embodiment.

Referring to FIG. 3, the display panel 100 may include a display area (DA) and a non-display area (NDA). The display panel 100 may include a plurality of pixels (SP) in the display area (DA). In the display area (DA), the display panel 100 may also include a power line (VL), a scan line (SL), and a data line (DL) connected to each respective one of the pixels (SP).

Each of the plurality of pixels (SP) may be connected to a scan line (SL), a data line (DL), and a power line (VL). Each of the plurality of pixels (SP) may include a transistor, a light-emitting element, and a capacitor.

The scan lines (SL) may extend in a first direction (DR1) and may be spaced apart from each other in a second direction (DR2) intersecting the first direction (DR1). The scan lines (SL) may sequentially supply scan signals to the plurality of pixels (SP).

The data lines (DL) may extend in a second direction (DR2) and may be spaced apart from each other in the first direction (DR1). The data lines (DL) may supply data voltages to the pixels (SP). The data voltages may determine the brightness of the pixels (SP).

The power lines (VL) may extend in a second direction (DR2) and may be spaced apart from each other in the first direction (DR1). The power line (VL) may supply power voltage to a plurality of pixels (SP).

The scan driver 250 may include a plurality of transistors and generate scan signals based on a scan control signal (SCS). The scan driver 250 may shift scan signals using a shift register and sequentially supply the shifted scan signals to scan lines (SL). The scan signals of the scan driver 250 may select pixels (SP) to which data voltages are supplied, and the selected pixels (SP) may receive the data voltages through data lines (DL). The scan driver 250 may be arranged on one or both sides of the non-display area (NDA) in a GIP (Gate In Panel) manner.

The timing controller 500 may receive digital video data (DATA) and a timing signal from a host system or a set module. The timing controller 500 may generate a data control signal (DCS) based on the timing signal. The timing controller 500 may control the operation timing of the display driver 200 by supplying the digital video data (DATA) and the data control signal (DCS) to the display driver 200. The display driver 200 may convert the digital video data (DATA) into analog data voltages and supply them to the data lines (DL). The timing controller 500 may generate a scan control signal (SCS) based on the timing signal. The timing controller 500 may control the operation timing of the scan driver 250 by supplying the scan control signal (SCS) to the scan driver 250. The timing controller 500 may vary the driving frequency of the display panel 100 based on the input frequency received from the host system or the set module.

The power supply unit 600 may supply a power voltage to the power line (VL). The power voltage may include, but is not limited to, one or more of a driving voltage (VDD), a low-potential voltage (VSS), an initialization voltage (Vint), a reference voltage (VREF), a bias voltage (Vbias), a source driving voltage (SVDD), a sensing reference voltage (EVRF), and an offset voltage (VRTA). The power supply unit 600 may generate a driving voltage (VDD) and supply it to the driving voltage line, generate an initialization voltage (Vint) and supply it to the initialization voltage line, generate a bias voltage (Vbias) and supply it to the bias voltage line, generate a reference voltage (VREF) and supply it to the reference voltage line, and generate a low-potential voltage (VSS) and supply it to the low-potential line. The reference voltage (VREF) may be used in the sensing process of the driving transistor or the anode electrode of the pixel (SP), and the source driving voltage (SVDD) may correspond to the total voltage required to drive the display driver 200. The low-potential voltage (VSS) may be a ground voltage, but is not limited thereto. The sensing reference voltage (EVRF) may set the range of the reference voltage (VREF) in the process of sensing the reference voltage (VREF), and the offset voltage (VRTA) may be used to adjust the gain of an analog-to-digital converter (ADC) of each of the plurality of display drivers 200.

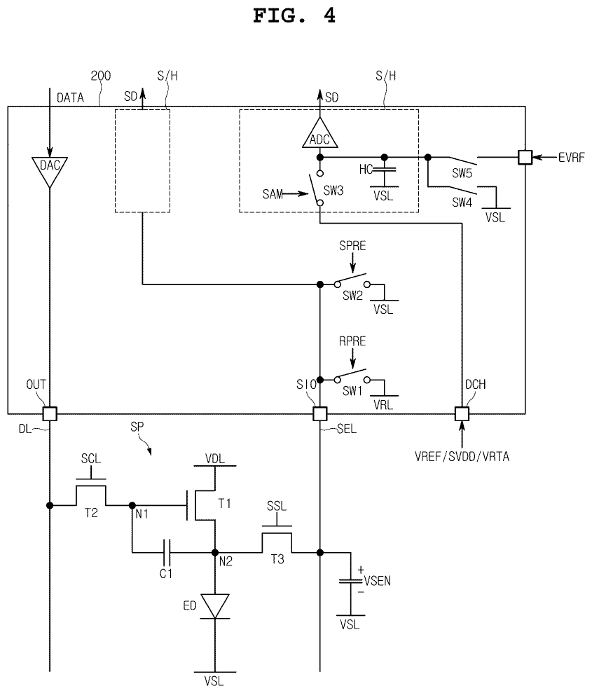

FIG. 4 is a diagram illustrating a display driver and pixels of a display device according to one example embodiment.

Referring to FIG. 4, each of a plurality of pixels (SP) may be connected to a first scan line (SCL), a second scan line (SSL), a data line (DL), a sensing line (SEL), a driving voltage line (VDL), and a low-potential line (VSL).

The pixel (SP) may include first to third transistors (T1, T2, and T3), a first capacitor (C1), and a light-emitting element (ED).

The first transistor (T1) may include a gate electrode, a drain electrode, and a source electrode. The gate electrode of the first transistor (T1) may be connected to a first node (N1), the drain electrode may be connected to the driving voltage line (VDL), and the source electrode may be connected to a second node (N2). The drain electrode of the first transistor (T1) may receive a driving voltage (VDD) from the driving voltage line (VDL). The first transistor (T1) may be a driving transistor that adjusts a current flowing from the driving voltage line (VDL) to the light-emitting element (ED) according to a voltage difference between the gate electrode and the source electrode. The first transistor (T1) may operate as a source follower. The first transistor (T1) may control a drain-source current (or, driving current) based on a data voltage applied to the gate electrode.

The light-emitting element (ED) may receive the driving current and emit light. The amount of light emitted or the brightness of the light-emitting element (ED) may be proportional to the magnitude of the driving current. The light-emitting element (ED) may include at least one of an organic light-emitting diode (OLED) including an organic light-emitting layer, a quantum dot light-emitting diode (QD) including a quantum dot light-emitting layer, an inorganic light-emitting diode (ILD) including an inorganic semiconductor, and a micro light-emitting diode (Micro LED), but is not limited thereto.

A first electrode of the light-emitting element (ED) may be connected to a second node (N2). The first electrode of the light-emitting element (ED) may be connected to a source electrode of a first transistor (T1), a drain electrode of a third transistor (T3), and a second capacitor electrode of a first capacitor (C1) via the second node (N2). The second electrode of the light-emitting element (ED) may be connected to a low-potential line (VSL). The second electrode of the light-emitting element (ED) may receive a low-potential voltage (VSS) from the low-potential line (VSL).

The second transistor (T2) may be turned on by the first scan signal of the first scan line (SCL) to electrically connect the data line (DL) and the first node (N1), which is the gate electrode of the first transistor (T1). The second transistor (T2) may be turned on based on the first scan signal to supply a data voltage to the first node (N1). The gate electrode of the second transistor (T2) may be connected to the first scan line (SCL), the drain electrode may be connected to the data line (DL), and the source electrode may be connected to the first node (N1). The source electrode of the second transistor (T2) may be electrically connected to the gate electrode of the first transistor (T1) and the first capacitor electrode of the first capacitor (C1) via the first node (N1).

The third transistor (T3) may be turned on by the second scan signal of the second scan line (SSL) to electrically connect the sensing line (SEL) and the second node (N2), which is the source electrode of the first transistor (T1). The third transistor (T3) may be turned on based on the second scan signal to supply the reference voltage (VREF) or the low-potential voltage (VSS) to the second node (N2). The gate electrode of the third transistor (T3) may be connected to the second scan line (SSL), the drain electrode may be connected to the second node (N2), and the source electrode may be connected to the sensing line (SEL). The drain electrode of the third transistor (T3) may be electrically connected to the source electrode of the first transistor (T1), the second capacitor electrode of the first capacitor (C1), and the first electrode of the light-emitting element (ED) via the second node (N2).

For example, the drain electrodes and source electrodes of each of the first to third transistors (T1, T2, T3) are not limited to the aforementioned description and may be formed opposite to each other. Each of the first to third transistors (T1, T2, T3) may be, but is not limited to, an N-type MOSFET (Metal Oxide Semiconductor Field Effect Transistor).

The display driver 200 may include an output channel (OUT), a sensing channel (SIO), a dummy channel (DCH), first and second switching elements (SW1, SW2), a sampling-holding module (S/H), fourth and fifth switching elements (SW4, SW5), and a digital-to-analog converter (DAC).

The display driver 200 may be electrically connected to a data line (DL) through the output channel (OUT). The display driver 200 outputs the data voltage (Vdata) generated from the digital-to-analog converter (DAC) through the output channel (OUT).

The display driver 200 may be electrically connected to the sensing line (SEL) via a sensing channel (SIO). The display driver 200 may supply a reference voltage (VREF) or a low-potential voltage (VSS) to the pixel (SP) via the sensing channel (SIO) and receive a sensing signal via the sensing channel (SIO).

The display driver 200 may receive a reference voltage (VREF), a source driving voltage (SVDD), and an offset voltage (VRTA) via a dummy channel (DCH). The dummy channel (DCH) of the display driver 200 may be directly connected to the sampling-holding module (S/H) (for example, the second sampling-holding module S/H hereinafter). Therefore, the reference voltage (VREF), the source driving voltage (SVDD), and the offset voltage (VRTA) applied via the dummy channel (DCH) may be directly supplied to the sampling-holding module (S/H).

The first switching element (SW1) may electrically connect the sensing line (SEL) to the reference voltage line (VRL) based on the first switching signal (RPRE). When the first switching element (SW1) is turned on, the reference voltage line (VRL) may supply the reference voltage (VREF) to the sensing line (SEL).

The second switching element (SW2) may electrically connect the sensing line (SEL) to the low-potential line (VSL) based on the second switching signal (SPRE). For example, the low-potential line (VSL) may be connected to ground, but is not limited thereto. When the second switching element (SW2) is turned on, the low-potential line (VSL) may supply the low-potential voltage (VSS) to the sensing line (SEL).

The sampling-holding module (S/H) may include a third switching element (SW3), an analog-to-digital converter (ADC), and a holding capacitor (HC). The sampling-holding module (S/H) (for example, the first sampling-holding module S/H hereinafter) may be electrically connected to a sensing line (SEL) via a sensing channel (SIO). The sampling-holding module (S/H) (for example, the second sampling-holding module S/H hereinafter) may be directly connected to a dummy channel (DCH). The third switching element (SW3) may electrically connect the sensing line (SEL) or the dummy channel (DCH) to an analog-to-digital converter (ADC) based on a third switching signal (SAM). When the third switching element (SW3) is turned on, the sensing line (SEL) may supply a sensing signal to the analog-to-digital converter (ADC), and the analog-to-digital converter (ADC) may convert the sensing signal into digital data to generate sensing data (SD). When the third switching element (SW3) is turned on, the dummy channel (DCH) may supply a reference voltage (VREF), a source driving voltage (SVDD), or an offset voltage (VRTA) to an analog-to-digital converter (ADC), and the analog-to-digital converter (ADC) may supply sensing data (SD) to a compensation circuit (not shown) of the timing controller 500.

The third switching element (SW3) may electrically connect the sensing line (SEL) or the dummy channel (DCH) to the hold capacitor (HC) based on the third switching signal (SAM). The hold capacitor (HC) may maintain a potential difference between the input terminal of the analog-to-digital converter (ADC) and the low-potential line (VSL). Therefore, the hold capacitor (HC) may hold a voltage applied to the input terminal of the analog-to-digital converter (ADC).

The fourth switching element (SW4) may electrically connect the low-potential line (VSL) to the analog-to-digital converter (ADC). The fourth switching element (SW4) may be turned on to supply the low-potential voltage (VSS) to the analog-to-digital converter (ADC). The analog-to-digital converter (ADC) may convert an analog voltage within a first voltage range from the low-potential voltage (VSS) into a digital signal. For example, when the low-voltage voltage (VSS) is 0 V and the first voltage range is 3 V, the analog-to-digital converter (ADC) may convert an analog voltage of 0 to 3 V into a 10-bit digital signal. The analog-to-digital converter (ADC) may convert a reference voltage (VREF) having a middle value of 1.5 V in the first voltage range into a digital signal of 512 code.

The fifth switching element (SW5) may supply a sensing reference voltage (EVRF) to the analog-to-digital converter (ADC). The analog-to-digital converter (ADC) may convert an analog voltage within the first voltage range from the sensing reference voltage (EVRF) into a digital signal. For example, when the sensing reference voltage (EVRF) is 0.01 V and the first voltage range is 3 V, the analog-to-digital converter (ADC) may convert an analog voltage of 0.01 to 3.01 V into a 10-bit digital signal. An analog-to-digital converter (ADC) may convert a reference voltage (VREF) having a middle value of 1.5 V in the first voltage range into a digital signal of 515 code.

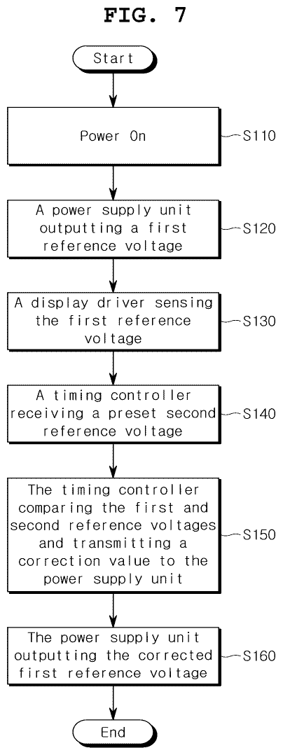

The display driver 200 may supply a value of the reference voltage (VREF) sensed based on the low-potential voltage (VSS) and a value of the reference voltage (VREF) sensed based on the sensing reference voltage (EVRF) to the timing controller 500. The timing controller 500 may compare the values of the sensed reference voltage (VREF) to correct the characteristics of the sensing reference voltage (EVRF), and the power supply unit 600 may output the corrected sensing reference voltage (EVRF). The display device 10 may correct the reference voltage (VREF), the source driving voltage (SVDD), and the offset voltage (VRTA) using the sensing reference voltage (EVRF) after performing a process of correcting the sensing reference voltage (EVRF). The correction process of the reference voltage (VREF), the source driving voltage (SVDD), and the sensing reference voltage (EVRF) is described in detail in the flowcharts of FIGS. 7 to 11. Accordingly, even if the control circuit board 400, the timing controller 500, and the power supply unit 600 are replaced after shipment from the manufacturer or through product repair, the display device 10 may correct the deviation of the power supply voltage to correct the sensing data and prevent the occurrence of the luminance deviation. In addition, the display device 10 may optimize the driving system and reduce power consumption by improving the dispersion of the control circuit board 400.

A digital-to-analog converter (DAC) may receive digital video data (DATA) reflecting sensing data (SD) from a compensation circuit of a timing controller 500. The digital-to-analog converter (DAC) may convert the digital video data (DATA) into analog data to generate a data voltage (Vdata). The digital-to-analog converter (DAC) may supply the data voltage (Vdata) to a data line (DL).

In one or more examples, the display driver 200 may include a plurality of sampling-holding modules (S/H). As an example, FIG. 4 illustrates two sampling-holding modules (S/H): a first sampling-holding module (S/H) connected to the sensing channel (SIO); and a second sampling-holding module (S/H) connected to the dummy channel (DCH). While the internal configuration (e.g., internal components and the connections thereof) of the first sampling-holding module (S/H) is not illustrated for brevity, in an example, the internal configuration of the first sampling-holding module (S/H) is the same as the internal configuration (e.g., ADC, SAM, SW3, HC and VSL) of the second sampling-holding module (S/H).

The first sampling-holding module (S/H) may include a third switching element (SW3), an analog-to-digital converter (ADC), and a holding capacitor (HC). The first sampling-holding module (S/H) may be electrically connected to the sensing line (SEL) via the sensing channel (SIO). The third switching element (SW3) of the first sampling-holding module (S/H) may electrically connect the sensing line (SEL) to the analog-to-digital converter (ADC) of the first sampling-holding module (S/H) based on a third switching signal (SAM). When the third switching element (SW3) of the first sampling-holding module (S/H) is turned on, the sensing line (SEL) may supply a sensing signal to the analog-to-digital converter (ADC) of the first sampling-holding module (S/H), and the analog-to-digital converter (ADC) of the first sampling-holding module (S/H) may convert the sensing signal into digital data to generate sensing data (SD). The analog-to-digital converter (ADC) of the first sampling-holding module (S/H) may supply its sensing data (SD) to a compensation circuit of the timing controller 500.

The third switching element (SW3) of the first sampling-holding module (S/H) may electrically connect the sensing line (SEL) to the hold capacitor (HC) based on the third switching signal (SAM) of the first sampling-holding module (S/H). The hold capacitor (HC) of the first sampling-holding module (S/H) may maintain a potential difference between the input terminal of the analog-to-digital converter (ADC) of the first sampling-holding module (S/H) and the low-potential line (VSL). Therefore, the hold capacitor (HC) of the first sampling-holding module (S/H) may hold a voltage applied to the input terminal of the analog-to-digital converter (ADC) of the first sampling-holding module (S/H).

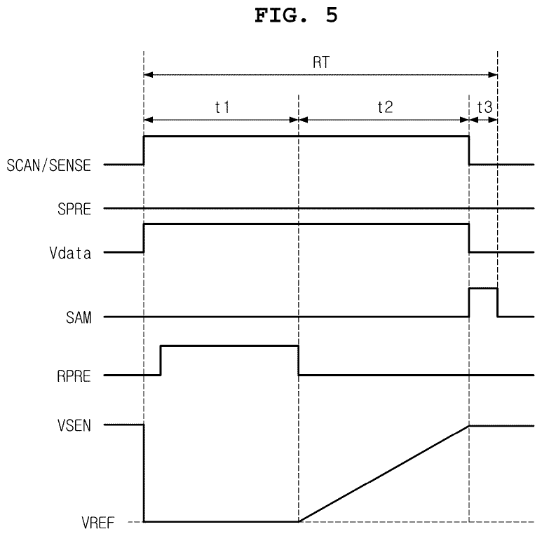

FIG. 5 is a timing diagram illustrating signals and voltages during a real time sensing (RT) period of a display device according to an example embodiment. The display device 10 may sense pixels in the real time sensing (RT) period between frames that display an image.

Referring to FIG. 5, a plurality of pixels (SP) may emit light during an active period. Pixels (SP) arranged in some rows among the plurality of pixels (SP) may be sensed by the display driver 200 during the RT period of a blank period. During the blank period, pixels (SP) arranged in other rows among the plurality of pixels (SP) may maintain the brightness they had during the previous active period. Accordingly, the RT period may be applied to pixels (SP) of some rows during the blank period. The display driver 200 may sense characteristics such as electron mobility or threshold voltage of the first transistor (T1) of the pixel (SP) during the RT period.

Referring to FIGS. 4 and 5, the RT period may include first to third periods (t1, t2, t3) that sequentially proceed. The pixel (SP) may receive a first scan signal (SCAN) of a high level (or gate-on voltage) and a second scan signal (SENSE) of a high level during the first and second periods (t1, t2). The second transistor (T2) may be turned on based on the first scan signal (SCAN), and the third transistor (T3) may be turned on based on the second scan signal (SENSE). The first scan signal (SCAN) may be received at the first scan line (SCL), and the second scan signal (SENSE) may be received at the second scan line (SSL).

The data line (DL) may supply a data voltage (Vdata) corresponding to sensing data to the pixel (SP) during the first and second periods (t1, t2). The second transistor (T2) may be turned on during the first and second periods (t1, t2) to supply the data voltage (Vdata) to the first node (N1), which is a gate electrode of the first transistor (T1). The first switching element (SW1) may receive a first switching signal (RPRE) of a high level during the first period (t1). The first switching element (SW1) may be turned on during the first period (t1) to electrically connect the reference voltage line (VRL) and the sensing line (SEL). The first switching element (SW1) may supply the reference voltage (VREF) of the reference voltage line (VRL) to the sensing line (SEL) during the first period (t1). The third transistor (T3) may be turned on during the first and second periods (t1, t2) to supply the reference voltage (VREF) to the second node (N2), which is the source electrode of the first transistor (T1).

The gate-source voltage (Vgs=Vdata−VREF) of the first transistor (T1) may be greater than the threshold voltage (Vth) of the first transistor (T1) during the first and second periods (t1, t2) (Vgs>Vth), and the first transistor (T1) may be turned on until the gate-source voltage (Vgs) of the first transistor (T1) reaches the threshold voltage (Vth) of the first transistor (T1). Accordingly, the voltage of the second node (N2), which is the source electrode of the first transistor (T1), may rise to “Vdata−Vth,” and the threshold voltage (Vth) of the first transistor (T1) may be sampled at the second node (N2).

The third switching element (SW3) may receive a high-level third switching signal (SAM) during a third period (t3). The third switching element (SW3) may electrically connect an analog-to-digital converter (ADC) to a sensing line (SEL) during the third period (t3). The sensing line (SEL) may have a sensing voltage (VSEN). The sensing voltage (VSEN) may be sensed as a sensing signal through the sensing line (SEL) and the analog-to-digital converter (ADC). The sensing voltage (VSEN) may have a reference voltage (VREF) during a first period (t1) of the RT period (RT) and may gradually increase during a second period (t2).

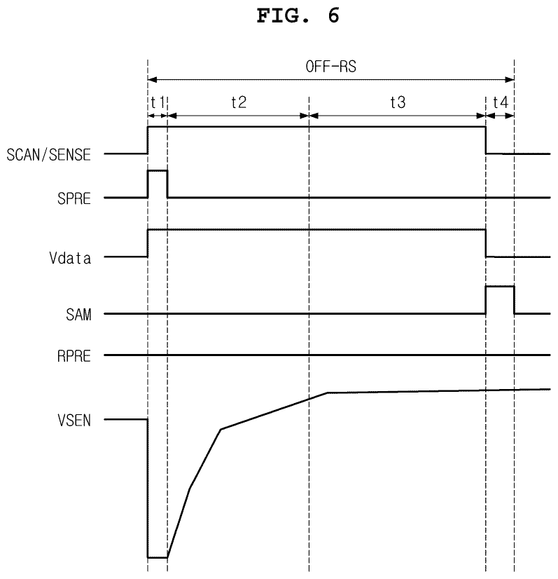

FIG. 6 is a timing diagram illustrating signals and voltages in an off-state real time sensing (OFF-RS) period of a display device according to one example embodiment. The OFF-RS period may correspond to a period during which pixels are sensed while the display device 10 is powered off and not displaying an image after being used for a certain period of time.

Referring to FIG. 6, the display device 10 may adjust the gain of the analog-to-digital converter (ADC) of each of the display drivers 200 during the OFF-RS period (OFF-RS). The OFF-RS period (OFF-RS) may include first to fourth periods (t1, t2, t3, t4) that are sequentially performed.

Referring to FIGS. 4 and 6, the pixel (SP) may receive a first scan signal (SCAN) of a high level (or gate-on voltage) and a second scan signal (SENSE) of a high level during the first to third periods (t1, t2, t3). The second transistor (T2) may be turned on based on the first scan signal (SCAN), and the third transistor (T3) may be turned on based on the second scan signal (SENSE).

The data line (DL) may supply a data voltage (Vdata) corresponding to sensing data to the pixel (SP) during the first to third periods (t1, t2, t3). The second transistor (T2) may be turned on during the first to third periods (t1, t2, t3) to supply the data voltage (Vdata) to the first node (N1), which is a gate electrode of the first transistor (T1). The second switching element (SW2) may receive a high-level second switching signal (SPRE) during the first period (t1). The second switching element (SW2) may be turned on during the first period (t1) to electrically connect the low-potential line (VSL) and the sensing line (SEL). The low-potential line (VSL) may supply the low-potential voltage (VSS) to the sensing line (SEL) during the first period (t1). The third transistor (T3) may be turned on during the first to third periods (t1, t2, t3) to supply a low-potential voltage (VSS) to the second node (N2), which is the source electrode of the first transistor (T1).

The gate-source voltage (Vgs=Vdata−VSS) of the first transistor (T1) may be greater than the threshold voltage (Vth) of the first transistor (T1) during the first to third periods (t1, t2, t3) (Vgs>Vth), and the first transistor (T1) may be turned on until the gate-source voltage (Vgs) of the first transistor (T1) reaches the threshold voltage (Vth) of the first transistor (T1). Accordingly, the voltage of the second node (N2), which is the source electrode of the first transistor (T1), may rise to “Vdata−Vth,” and the threshold voltage (Vth) of the first transistor (T1) may be sampled at the second node (N2).

The third switching element (SW3) may receive a high-level third switching signal (SAM) during a fourth period (t4). The third switching element (SW3) may electrically connect an analog-to-digital converter (ADC) to the sensing line (SEL) during the fourth period (t4). The sensing line (SEL) may have a sensing voltage (VSEN). The sensing voltage (VSEN) may be sensed as a sensing signal through the sensing line (SEL) and the analog-to-digital converter (ADC). The sensing voltage (VSEN) may have a low-potential voltage (VSS) during a first period (t1) and may gradually increase during a second period (t2). The sensing voltage (VSEN) may have a maximum value during the third and fourth periods (t3, t4).

FIG. 7 is a flowchart illustrating a process of correcting a first reference voltage in a power-on state of a display device according to one example embodiment. Hereinafter, the first reference voltage may correspond to a reference voltage (VREF) used for driving the display device 10. The second reference voltage may correspond to a reference voltage (VREF) used by a manufacturer of the display panel 100 to set a default value. The reference voltage (VREF) may be used in the sensing process of the driving transistor or the anode electrode of the pixel (SP).

The source circuit board 300 may be manufactured by the same manufacturer as the display panel 100 and delivered to the customer. The source circuit board 300 may be electrically connected to a setting control circuit board 401, a setting timing controller 501, and a setting power supply unit 601 at the manufacturer. The setting power supply unit 601 may output a second reference voltage, and the display driver 200 may sense the second reference voltage. The memory 700 may be delivered to the customer with the second reference voltage stored therein.

The source circuit board 300 may be electrically connected to a control circuit board 400, a timing controller 500, and a power supply unit 600 at the customer.

The display device 10 may be configured to display an image in a power-on state (step S110) and may correct the first reference voltage at regular intervals, as described below.

The power supply unit 600 may output a first reference voltage (step S120). The first reference voltage may be directly supplied to the sample-and-hold module (S/H) via a dummy channel (DCH).

The display driver 200 may sense a first reference voltage as an analog signal (step S130). An analog-to-digital converter (ADC) may convert the analog voltage into a digital signal.

The timing controller 500 may receive a previously stored second reference voltage (step S140). In this regard, in an example, the timing controller 500 may receive the second reference voltage from the memory 700, where the second reference voltage was previously output by the setting power supply unit 601 and was previously stored in the memory 700.

The timing controller 500 may compare the first and second reference voltages and transmit a correction value to the power supply unit 600 (step S150). In this regard, in an example, the timing controller 500 may compare the digital signals of the first and second reference voltages, respectively, and calculate an error value. The timing controller 500 may calculate a correction value of the first reference voltage by reflecting the error value. The timing controller 500 may transmit the correction value of the first reference voltage to the power supply unit 600.

The power supply unit 600 may receive the correction value of the first reference voltage from the timing controller 500. The power supply unit 600 may output the corrected first reference voltage (step S160). The first reference voltage may be supplied to the display driver 200 through the reference voltage line (VRL). The display driver 200 may receive the first reference voltage and supply it to the pixel (SP).

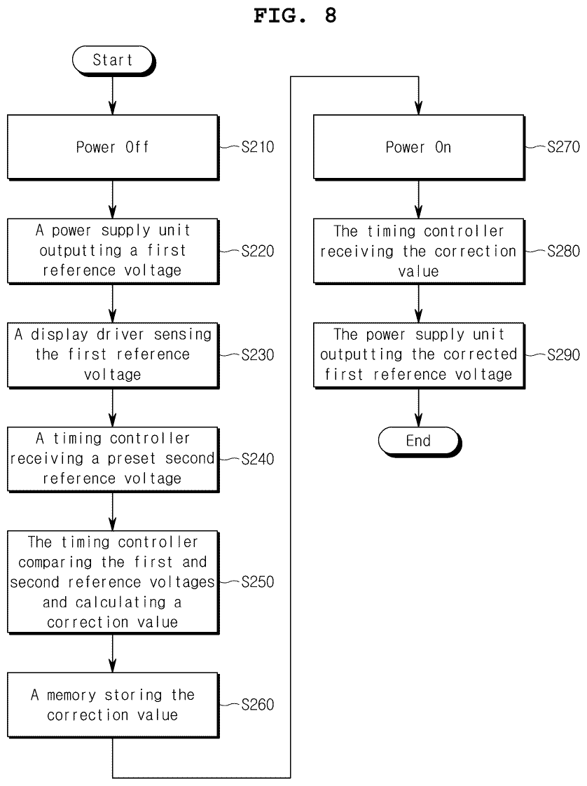

FIG. 8 is a flowchart illustrating a process for correcting a first reference voltage in a power-off state of a display device according to one example embodiment. In one or more examples, the power-off state may correspond to immediately before powering off the display device 10 or immediately after powering on the display device 10. In the power-off state, the display panel 100 does not display an image, and the display driver 200 may adjust a set value.

Referring to FIG. 8, the display device 10 may be configured to not display an image in the power-off state (step S210), and may correct the first reference voltage, as described below.

The power supply unit 600 may output a first reference voltage (step S220). The first reference voltage may be directly supplied to the sampling-holding module (S/H) via a dummy channel (DCH).

The display driver 200 may sense the first reference voltage as an analog voltage (step S230). An analog-to-digital converter (ADC) may convert the analog voltage into a digital signal.

The timing controller 500 may receive a previously stored second reference voltage (step S240). In this regard, in an example, the timing controller 500 may receive the second reference voltage from the memory 700, where the second reference voltage was previously output by the setting power supply unit 601 and was previously stored in the memory 700.

The timing controller 500 may compare the first and second reference voltages to calculate a correction value (step S250). In this regard, in an example, the timing controller 500 may compare the digital signals of the first and second reference voltages, respectively, and calculate an error value. The timing controller 500 may calculate a correction value of the first reference voltage by reflecting the error value. The timing controller 500 may transmit the correction value for the first reference voltage to the memory 700.

The memory 700 may store the correction value for the first reference voltage (step S260). The correction value stored in the memory 700 may be used in the power-on state.

The display device 10 may display an image in the power-on state (step S270).

The timing controller 500 may receive the stored correction value for the first reference voltage in the power-on state (step S280). The timing controller 500 may transmit the correction value for the first reference voltage to the power supply unit 600.

The power supply unit 600 may receive a correction value of the first reference voltage from the timing controller 500. The power supply unit 600 may output the corrected first reference voltage (step S290). The first reference voltage may be supplied to the display driver 200 through the reference voltage line (VRL). The display driver 200 may receive the first reference voltage and supply it to the pixel (SP).

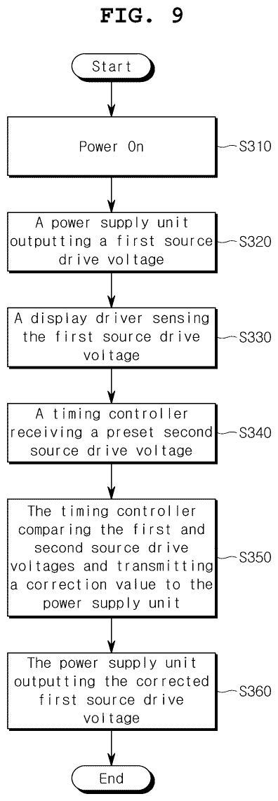

FIG. 9 is a flowchart illustrating a process for correcting a first source driving voltage in a power-on state of a display device according to one example embodiment. The process for correcting the first source driving voltage may be substantially the same as the process for correcting the first reference voltage. Therefore, components identical to the aforementioned configuration will be briefly described or omitted, and unless otherwise indicated, components identified by the same reference numerals in different figures have the same descriptions.

Referring to FIG. 9, the first source driving voltage may correspond to a source driving voltage (SVDD) used to drive the display device 10. The second source driving voltage may correspond to a source driving voltage (SVDD) used by the manufacturer of the display panel 100 to set a default value. The source driving voltage (SVDD) may correspond to the total voltage required to drive the display driver 200.

The display device 10 may be configured to display an image in a power-on state (step S310) and may correct the first source driving voltage at regular intervals, as described below.

The power supply unit 600 may output the first source driving voltage to a dummy channel (DCH) (step S320).

The analog-to-digital converter (ADC) of the display driver 200 may sense the first source driving voltage (step S330).

The timing controller 500 may receive a pre-stored second source driving voltage from the memory 700 (step S340).

The timing controller 500 may compare the first and second source driving voltages to calculate a correction value of the first source driving voltage and transmit the correction value to the power supply unit 600 (step S350).

The power supply unit 600 may receive the correction value of the first source driving voltage from the timing controller 500 and output the corrected first source driving voltage (step S360).

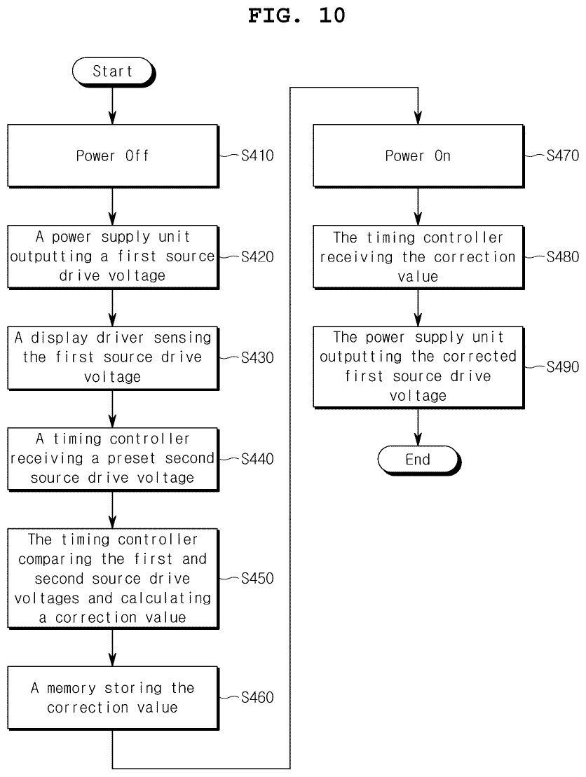

FIG. 10 is a flowchart illustrating a process for correcting a first source driving voltage in a power-off state of a display device according to one example embodiment.

Referring to FIG. 10, the display device 10 may be configured to not display an image in a power-off state (step S410) and may correct the first source driving voltage, as described below.

The power supply unit 600 may output the first source driving voltage to a dummy channel (DCH) (step S420).

The analog-to-digital converter (ADC) of the display driver 200 may sense the first source driving voltage (step S430).

The timing controller 500 may receive a pre-stored second source driving voltage from the memory 700 (step S440).

The timing controller 500 may compare the first and second source driving voltages to calculate a correction value (step S450).

The memory 700 may store the correction value of the first source driving voltage received from the timing controller 500 (step S460).

The display device 10 may be configured to display an image in a powered-on state (step S470).

The timing controller 500 may receive the stored correction value of the first source driving voltage in a powered-on state (step S480).

The power supply unit 600 may receive the correction value of the first source driving voltage from the timing controller 500 and output the corrected first source driving voltage (step S490).

Additionally, the offset voltage (VRTA) may also be corrected through a process substantially identical to the correction process of the reference voltage (VREF) and the source driving voltage (SVDD) illustrated in FIGS. 7 to 10.

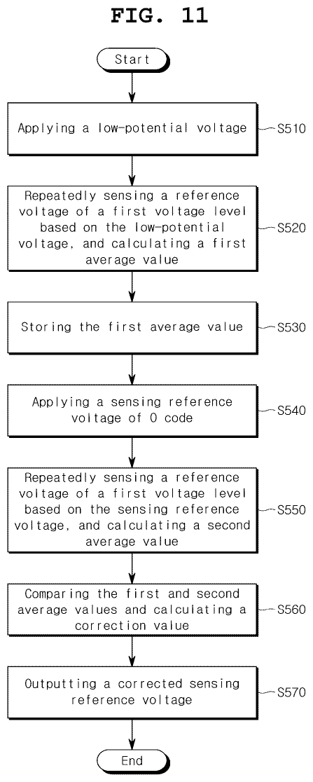

FIG. 11 is a flowchart illustrating a process of correcting a sensing reference voltage of a display device according to one example embodiment.

Referring to FIGS. 4 and 11, the fourth switching element (SW4) may electrically connect the low-potential line (VSL) to an analog-to-digital converter (ADC). The low-potential voltage (VSS) may be applied to the analog-to-digital converter (ADC) of the display driver 200 (step S510).

An analog-to-digital converter (ADC) may repeatedly sense a reference voltage (VREF) having a first voltage level based on a low-potential voltage (VSS), and a timing controller 500 may calculate a first average value of the sensed values (step S520). The analog-to-digital converter (ADC) may convert an analog voltage within a first voltage range from the low-potential voltage (VSS) into a digital signal. For example, when the low-potential voltage (VSS) is 0 V and the first voltage range is 3 V, the analog-to-digital converter (ADC) may convert an analog voltage of 0 to 3 V into a 10-bit digital signal. The analog-to-digital converter (ADC) may convert a reference voltage (VREF) having a middle value of 1.5 V in the first voltage range into a digital signal of 512, 511, or 513 code. An analog-to-digital converter (ADC) may repeat the process of sensing a reference voltage (VREF) multiple times, and a timing controller 500 may calculate an average value of the multiple digital signals. The timing controller 500 may calculate a 512 code as a first average value and supply it to the memory 700.

The memory 700 may store the first average value received from the timing controller 500 (step S530).

The fifth switching element (SW5) may supply a sensing reference voltage (EVRF) of the 0 code to the analog-to-digital converter (ADC) (step S540). For example, while the sensing reference voltage (EVRF) of an ideal 0 code may be substantially equal to the low-potential voltage (VSS), the actual sensing reference voltage (EVRF) of the 0 code may have some error from the low-potential voltage (VSS).

The analog-to-digital converter (ADC) may repeatedly sense the reference voltage (VREF) of the first voltage level based on the sensing reference voltage (EVRF) of the 0 code, and the timing controller 500 may calculate a second average value of the sensed values (step S550). The analog-to-digital converter (ADC) may convert an analog voltage within a first voltage range from the sensing reference voltage (EVRF) of the 0 code into a digital signal. For example, when the sensing reference voltage (EVRF) is 0.01 V and the first voltage range is 3 V, the analog-to-digital converter (ADC) may convert an analog voltage of 0.01 to 3.01 V into a 10-bit digital signal. The analog-to-digital converter (ADC) may convert the reference voltage (VREF) having a middle value of 1.5 V in the first voltage range, into a digital signal of 515, 514, and 516 codes. An analog-to-digital converter (ADC) may repeat the process of sensing a reference voltage (VREF) multiple times, and the timing controller 500 may calculate an average value of the multiple digital signals. The timing controller 500 may calculate a code of 515 as the second average value.

The timing controller 500 may compare the first and second average values to calculate a correction value for the sensing reference voltage (EVRF) (step S560). The timing controller 500 may receive the first average value from the memory 700 and compare it with the calculated second average value. The timing controller 500 may calculate the correction value by reflecting the error value of the three codes.

The power supply unit 600 may receive the correction value from the timing controller 500 and output the corrected sensing reference voltage (EVRF) (step S570). The display device 10 may correct the reference voltage (VREF), the source driving voltage (SVDD), and the offset voltage (VRTA) using the sensing reference voltage (EVRF) after performing a process of correcting the sensing reference voltage (EVRF).

Therefore, even if the control circuit board 400, the timing controller 500, and the power supply unit 600 are replaced after the manufacturer ships the display device 10 or during product repair, the display device 10 may correct the sensing data (SD) by correcting the deviation in the power supply voltage and prevent the occurrence of brightness deviation.

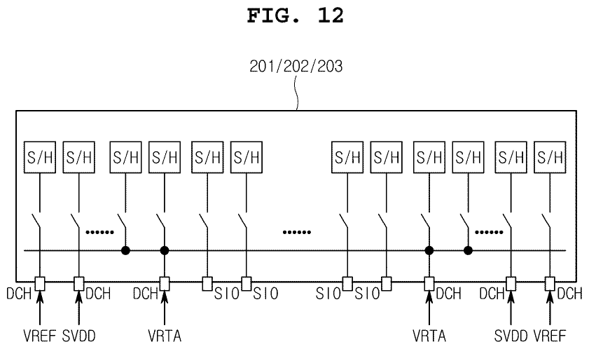

FIG. 12 is a diagram illustrating first to third display drivers of a display device according to one example embodiment.

Referring to FIG. 12, the display driver 200 may include first to third display drivers 201, 202, and 203. The first display driver 201 may be positioned closest to the control circuit board 400 or the flexible cable 320, and the third display driver 203 may be positioned furthest from the control circuit board 400 or the flexible cable 320.

Each of the first to third display drivers 201, 202, 203 may include one or more sensing channels (SIO) and one or more dummy channels (DCH). Each of the first to third display drivers 201, 202, 203 may include one or more output channels (OUT), but these are not illustrated in FIG. 12 simply for brevity.

Each of the first to third display drivers 201, 202, 203 may receive a reference voltage (VREF) through a part of dummy channels (DCH) among the plurality of dummy channels (DCH). The dummy channel (DCH) may be directly connected to the sampling-holding module (S/H). In connection with FIG. 4, the reference voltage (VREF) applied through the dummy channel (DCH) may be directly supplied to the sampling-holding module (S/H), and the third switching element (SW3) of the sampling-holding module (S/H) may transmit the reference voltage (VREF) to an analog-to-digital converter (ADC). The analog-to-digital converter (ADC) may convert the reference voltage (VREF) of an analog value into a digital code. Therefore, the sampling-holding module (S/H) of each display driver may sense the reference voltage (VREF) and transmit the sensing data (SD) of the digital value to the timing controller 500.

Each of the first to third display drivers 201, 202, 203 may receive a source driving voltage (SVDD) through another dummy channel (DCH) among a plurality of dummy channels (DCH). The dummy channel (DCH) may be directly connected to the sampling-holding module (S/H). In connection with FIG. 4, the source driving voltage (SVDD) applied through the dummy channel (DCH) may be directly supplied to the sampling-holding module (S/H), and the third switching element (SW3) of the sampling-holding module (S/H) may transmit the source driving voltage (SVDD) to an analog-to-digital converter (ADC). The analog-to-digital converter (ADC) may convert the source driving voltage (SVDD) of an analog value into a digital code. Accordingly, the sampling-holding module (S/H) of each display driver may sense the source driving voltage (SVDD) and transmit the sensing data (SD) of the digital value to the timing controller 500.

Each of the first to third display drivers 201, 202, 203 may receive an offset voltage (VRTA) through a remaining part of dummy channels (DCH) among the plurality of dummy channels (DCH). In one or more examples, a dummy channel (DCH) of each display driver may be configured to be connected to a plurality of sampling-holding modules (S/H). The offset voltage (VRTA) may be supplied simultaneously to the plurality of sampling-holding modules (S/H) of each display driver. Each of the plurality of sampling-holding modules (S/H) may sense the offset voltage VRTA, and the offset voltage (VRTA) of the analog value may be converted into a digital code through a corresponding one of the plurality of analog-to-digital converters (ADCs). Each of the plurality of sampling-holding modules (S/H) may sense the offset voltage (VRTA) and transmit the sensing data (SD) of the digital value to the timing controller 500. The offset voltage (VRTA) may be sensed by each of the plurality of sampling-holding modules (S/H), thereby minimizing sensing deviation. The timing controller 500 may calculate an average value of a plurality of sensing data (SD) to determine a correction value for the gain (Gain) of an analog-to-digital converter (ADC). Accordingly, the timing controller 500 may compare the sensing data (SD) of the display drivers 200 to adjust the gain (Gain) of the analog-to-digital converter (ADC) of each of the display drivers 200.

The offset voltage (VRTA) may be supplied to the left dummy channels (DCH) and the right dummy channels (DCH) of each of the first to third display drivers 201, 202, and 203. The left dummy channels (DCH) and the right dummy channels (DCH) may have a reference temperature deviation or characteristic deviation of the display driver 200. Accordingly, the offset voltage (VRTA) is supplied to each of the left dummy channels (DCH) and the right dummy channels (DCH), thereby allowing the characteristic distribution for all dummy channels (DCH) to be confirmed.

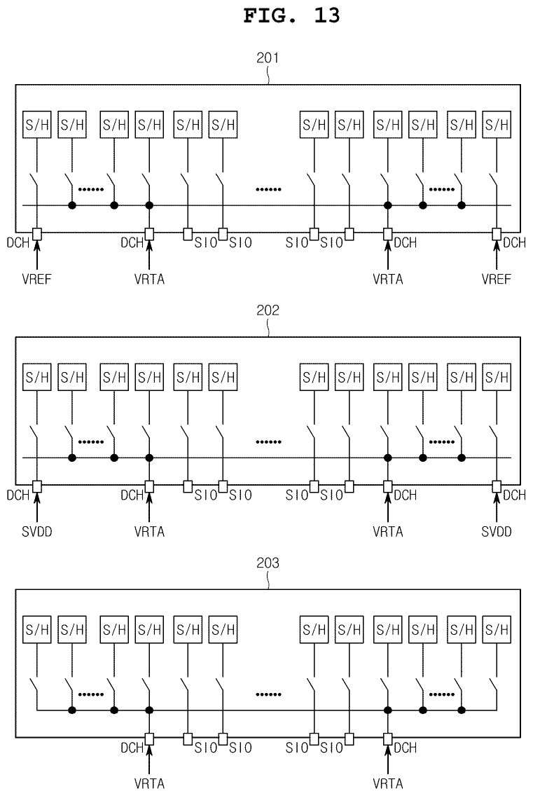

FIG. 13 is a diagram showing first to third display drivers of a display device according to another example embodiment. The first to third display drivers of FIG. 13 disclose a configuration that is somewhat different from the first to third display drivers of FIG. 12, and thus, the same configuration as the aforementioned configuration will be briefly described or omitted. Unless otherwise indicated, components identified by the same reference numerals in different figures have the same descriptions.

Referring to FIG. 13, each of the first to third display drivers 201, 202, and 203 may include one or more sensing channels (SIO) and one or more dummy channels (DCH). The first to third display drivers 201, 202, and 203 may include one or more output channels (OUT), but these are not illustrated in FIG. 13 simply for brevity.

The first display driver 201 may receive a reference voltage (VREF) through some of the dummy channels (DCH) among the plurality of dummy channels (DCH), and receive an offset voltage VRTA through a remaining part of dummy channels DCH among the plurality of dummy channels DCH. The reference voltage (VREF) applied through the dummy channel (DCH) of the first display driver 201 may be directly supplied to the sampling-holding module (S/H).

The second display driver 202 may receive a source driving voltage (SVDD) through some of the dummy channels (DCH) among the plurality of dummy channels (DCH), and receive an offset voltage VRTA through a remaining part of dummy channels DCH among the plurality of dummy channels DCH. The source driving voltage (SVDD) applied through the dummy channel (DCH) of the second display driver 202 may be directly supplied to the sampling-holding module (S/H).

Each of the first to third display drivers 201, 202, and 203 may receive an offset voltage (VRTA) through the dummy channel (DCH). In one or more examples, a dummy channel (DCH) of each display driver may be configured to be connected to a plurality of sampling-holding modules (S/H). An offset voltage (VRTA) may be simultaneously supplied to the plurality of sampling-holding modules (S/H) of each display driver. The sampling-holding module (S/H) may sense the offset voltage (VRTA) and transmit the sensed data (SD) of the digital value to the timing controller 500. The timing controller 500 may compare the sensed data (SD) of the display drivers 200 and adjust the gain of the analog-to-digital converter (ADC) of each of the display drivers 200.

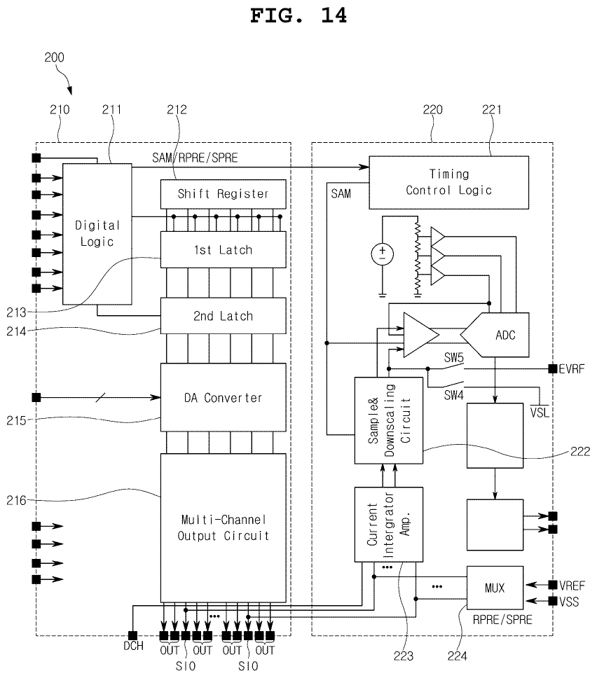

FIG. 14 is a block diagram illustrating a driving module and a sensing module of the display driver in a display device according to one example embodiment.

Referring to FIG. 14, the display driver 200 may include a driving module 210 and a sensing module 220. The driving module 210 may include a digital logic 211, a shift register 212, a first latch 213, a second latch 214, a digital-to-analog converter 215, and a multi-channel output circuit 216. The driving module 210 may include one or more output channels (OUT), one or more sensing channels (SIO), and one or more dummy channels (DCH).

The digital logic 211 may operate on an input signal and supply it to the shift register 212, the first latch 213, and the second latch 214.

The first latch 213 may receive signals from the digital logic 211 and the shift register 212 and transmit an output value to the second latch 214.

The second latch 214 may receive signals from the digital logic 211 and the first latch 213 and transmit an output value to the digital-to-analog converter 215.

The digital-to-analog converter 215 may receive an input signal and a signal from the second latch 214 and transmit an output value to the multi-channel output circuit 216.

The multi-channel output circuit 216 may receive an input signal and a signal from the digital-to-analog converter 215 and supply a data voltage corresponding to digital video data (DATA). The multi-channel output circuit 216 may supply the data voltage to the data line (DL) through an output channel (OUT).

The sensing module 220 may include a timing control logic 221, a sample downscaling circuit 222, a current integration circuit 223, an analog-to-digital converter (ADC), fourth and fifth switching elements (SW4, SW5), and a multiplexer 224. The sample downscaling circuit 222 may be referred to as a sample & downscaling circuit. The current integration circuit 223 may be referred to as a current integrator amplifier.

The timing control logic 221 may receive the first to third switching signals (RPRE, SPRE, SAM) and output an appropriate switching signal according to timing. The timing control logic 221 may supply the third switching signal (SAM) to the sample downscaling circuit 222. The sample downscaling circuit 222 may include the third switching element (SW3) illustrated in FIG. 4.

The current integration circuit 223 may receive the sensing voltage (VSEN) stored in the sensing line (SEL) as a sensing signal. The current integration circuit 223 may supply the sensing signal to the sample downscaling circuit 222. An analog-to-digital converter (ADC) may convert the sensing signal downscaled by the sample downscaling circuit 222 into digital data to generate sensing data (SD).

The fourth switching element (SW4) may electrically connect the low-potential line (VSL) to the analog-to-digital converter (ADC). The fifth switching element (SW5) may supply the sensing reference voltage (EVRF) to the analog-to-digital converter (ADC).

The multiplexer 224 may supply one of the reference voltage (VREF) and the low-potential voltage (VSS) to the sensing line (SEL). The multiplexer 224 may supply the reference voltage (VREF) to the sensing line (SEL) based on the first switching signal (RPRE). The multiplexer 224 may supply the low-potential voltage (VSS) to the sensing line (SEL) based on the second switching signal (SPRE). Therefore, the reference voltage line (VRL) supplying the reference voltage (VREF) and the low-potential line (VSL) supplying the low-potential voltage (VSS) may be applied to the display driver 200 through a channel directly connected to the multiplexer 224.

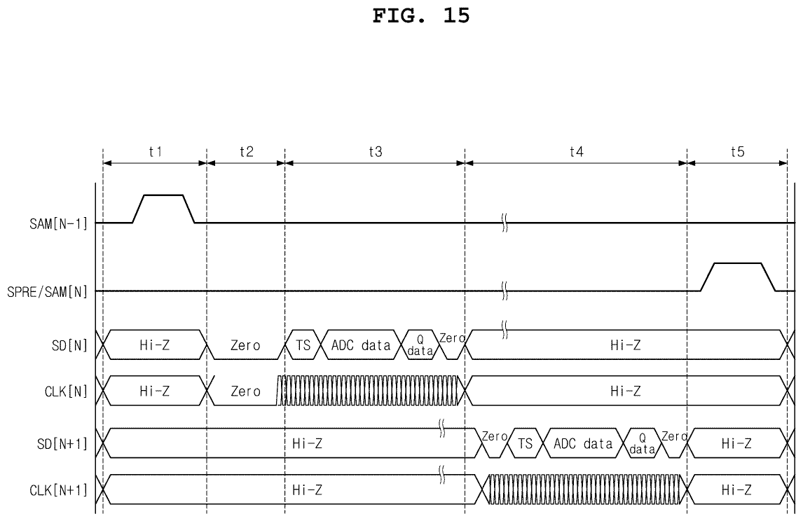

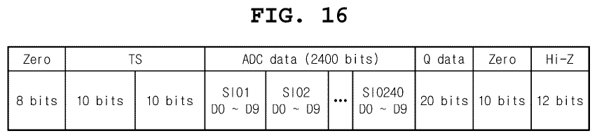

FIG. 15 is a waveform diagram showing voltages and signals applied to a display device according to one example embodiment, and FIG. 16 is a diagram showing the configuration of a data voltage of the display device according to one example embodiment.

Referring to FIGS. 15 and 16, a plurality of sampling-holding modules (S/H) may include an (N−1)th (N is an integer greater than or equal to 2) sampling-holding module (S/H), an Nth sampling-holding module (S/H), and an (N+1)th sampling-holding module (S/H). Each of the (N−1)th, Nth, and (N+1)th sampling-holding modules (S/H) may include, provide, be provided with, be electrically connectable to, be controlled by, or operate with, a second switching signal (SPRE), a third switching signal (SAM), a third switching element (SW3), an analog-to-digital converter (ADC), sensing data (SD), and a clock signal (CLK).

The (N−1)th third switching signal (SAM[N−1]) of the (N−1)th sampling-holding module S/H may be supplied to the third switching element (SW3) of the (N−1)th sampling-holding module S/H connected to an (N−1)th sensing line (SEL) during a first period (t1). The (N−1)th third switching element (SW3) of the (N−1)th sampling-holding module S/H may electrically connect the (N−1)th sensing line (SEL) and the analog-to-digital converter (ADC) of the (N−1)th sampling-holding module S/H during a first period (t1).

The Nth second and third switching signals (SPRE/SAM[N]) may be supplied to the Nth second and third switching elements (SW2, SW3) connected to the Nth sensing line (SEL) during a fifth period (t5).

The Nth sensing data (SD[N]) output from the Nth analog-to-digital converter (ADC) may have a signal corresponding to a high impedance (Hi-Z) state during the first period (t1). The Nth sensing data (SD[N]) may have zero data during the second period (t2). The zero data of the second period (t2) may include, but is not limited to, an 8-bit signal.

The Nth sensing data (SD[N]) may supply an actual data value to the timing controller 500 during a third period (t3). The Nth sensing data (SD[N]) may include a transmission start signal (TS), analog-to-digital conversion data (ADC data), Q data (Q data), and zero data during the third period (t3). The transmission start signal (TS) can signal the start of transmission of the analog-to-digital conversion data (ADC data). The transmission start signal (TS) may include a 20-bit signal, but is not limited thereto. The analog-to-digital conversion data (ADC data) may have a digital conversion value of an Nth analog-to-digital converter (ADC) corresponding to (or connectable to) a plurality of sensing channels (SIO). The analog-to-digital conversion data (ADC data) may include a 10-bit signal for each sensing channel (SIO). For example, when the display driver 200 includes 240 sensing channels (SIO1 to SIO240), the analog-to-digital conversion data (ADC data) may include a 2400-bit signal, but is not limited thereto. The Q data (Q data) may include phase information of the Nth sensing data (SD[N]). The Q data (Q data) may include a 20-bit signal, but is not limited thereto. The zero data of the third period (t3) may include a 10-bit signal, but the example embodiments are not limited thereto.

The Nth sensing data (SD[N]) may have a signal corresponding to a high impedance (Hi-Z) state during the fourth and fifth periods (t4, t5). The zero data of the second period (t2) may include, but is not limited to, a 12-bit signal.

The Nth clock signal (CLK[N]) may have a signal corresponding to a high impedance (Hi-Z) state during the first period (t1) and may have zero data during the second period (t2). The clock signal (CLK[N]) may have a pulse signal in which high and low levels are repeated during the third period (t3). The clock signal (CLK[N]) may have a signal corresponding to a high impedance (Hi-Z) state during the fourth and fifth periods (t4, t5).

The (N+1)th sensing data (SD[N+1]) output from the (N+1)th analog-to-digital converter (ADC) may have a signal corresponding to a high impedance (Hi-Z) state during the first to third periods (t1, t2, t3). The (N+1)th sensing data (SD[N+1]) may include zero data, a transmission start signal (TS), analog-to-digital conversion data (ADC data), Q data (Q data), and zero data during the fourth period (t4). The (N+1)th sensing data (SD[N+1]) may have a signal corresponding to a high impedance (Hi-Z) state during the fifth period (t5).

The (N+1)th clock signal (CLK[N+1]) may have a signal corresponding to a high impedance (Hi-Z) state during the first to third periods (t1, t2, t3). The (N+1)th clock signal (CLK[N+1]) may have a pulse signal that repeats between high and low levels during a fourth period (t4). The (N+1)th clock signal (CLK[N+1]) may have a signal corresponding to a high impedance (Hi-Z) state during a fifth period (t5).

Various examples and aspects of the present disclosure are described below. These are provided as examples, and do not limit the scope of the present disclosure.

In one or more examples, a reference voltage (VREF) received through a dummy channel (DCH) of a display driver may be the same as, or different from, a reference voltage (VREF) received through another dummy channel (DCH) of the same display driver. A reference voltage (VREF) received by a dummy channel (DCH) of a display driver may be the same as, or different from, a reference voltage (VREF) received by a dummy channel (DCH) of another display driver.

In one or more examples, a source driving voltage (SVDD) received through a dummy channel (DCH) of a display driver may be the same as, or different from, a source driving voltage (SVDD) received through another dummy channel (DCH) of the same display driver. A source driving voltage (SVDD) received by a dummy channel (DCH) of a display driver may be the same as, or different from, a source driving voltage (SVDD) received by a dummy channel (DCH) of another display driver.

In one or more examples, an offset voltage (VRTA) supplied to the left dummy channels (DCH) of a display driver may be the same as, or different from, an offset voltage (VRTA) supplied to the right dummy channels (DCH) of the same display driver. An offset voltage (VRTA) supplied to the left dummy channels (DCH) of a display driver may be the same as, or different from, an offset voltage (VRTA) supplied to the left and/or right dummy channels (DCH) of another display driver.

In one or more examples, a switching element may be referred to as a switch, a first switching element may be referred to as a first switch, a second switching element may be referred to as a second switch, a third switching element may be referred to as a third switch, a fourth switching element may be referred to as a fourth switch, and a fifth switching element may be referred to as a fifth switch.

In one or more examples, a statement that the timing controller compares the voltages (e.g., the first and second reference voltages, or the first and second source driving voltages) may be understood as the timing controller comparing values of the voltages (or values representing the voltages, or digital values representing the voltages).

In one or more examples, a statement that the timing controller receives a voltage (e.g., a second reference voltage stored in the memory) may be understood as the timing controller receiving a value of the voltage (or a value representing the voltage, or a digital value representing the voltage).

In one or more examples, a statement that the timing controller corrects a voltage (e.g., a first reference voltage) may be understood as the timing controller correcting a value of the voltage (or a value representing the voltage, or a digital value representing the voltage).

In one or more examples, a statement that the timing controller transmits a voltage (e.g., a correction value of the first reference voltage) may be understood as the timing controller transmitting a value of the voltage (or a value representing the voltage, or a digital value representing the voltage).

In one or more examples, a statement that the memory stores a voltage (e.g., a source driving voltage, a second source driving voltage, a reference voltage, or a second reference voltage) may be understood as the memory storing a value of the voltage (or a value representing the voltage, or a digital value representing the voltage).

In one or more examples, an analog value may include an analog signal, and vice versa. A digital signal may include a digital code, and vice versa.

In one or more examples, a signal or the signal may include one or more signals, an input signal or the input signal may include one or more input signals, a value or the value may include one or more values, an output value or the output value may include one or more output values, an output channel or the output channel may include one ore more output channels, a dummy channel or the dummy channel may include one or more dummy channels, a sensing channel or the sensing channel may include one or more sensing channels, a data line or the data line may include one or more data lines, a sensing line or the sensing line may include one or more sensing lines, a pixel or the pixel may include one or more pixels, a light-emitting element or the light-emitting element may include one or more light-emitting elements, a data driver or the data driver may include one or more data drivers, a sensing signal or the sensing signal may include one or more sensing signals, a sampling-holding module or the sampling-holding module may include one or more sampling-holding modules, and an analog-to-digital converter or the analog-to-digital converter may include one or more analog-to-digital converters.

In one or more examples, a voltage or the voltage may include one or more voltages, a data voltage or the data voltage may include one or more data voltages, a low-potential voltage or the low-potential voltage may include one or more low-potential voltages, a reference voltage or the reference voltage may include one or more reference voltages, a sensing reference voltage or the sensing reference voltage may include one or more sensing reference voltages, an offset voltage or the offset voltage may include one or more offset voltages, and a source driving voltage or the source driving voltage may include one or more source driving voltages.

In one or more examples, a statement that a component receives the reference voltage through some of the plurality of dummy channels may be understood as the component receiving one or more reference voltages through some of the plurality of dummy channels (e.g., each of the some of the plurality of dummy channels may receive a respective reference voltage). A statement that a component receives the source driving voltage through some of the other dummy channels may be understood as the component receiving one or more source driving voltages through some of the other dummy channels (e.g., each of the some of the other dummy channels may receive a respective source driving voltage). A statement that a component receives the offset voltage through some of the other dummy channels may be understood as the component receiving one or more offset voltages through some of the other dummy channels (e.g., each of the some of the other dummy channels may receive a respective offset voltage).

In one or more examples, a statement that a component receives the reference voltage through some of dummy channels among the plurality of dummy channels may be understood as the component receiving one or more reference voltages through some of dummy channels among the plurality of dummy channels (e.g., each of the some of the dummy channels may receive a respective reference voltage). A statement that a component receives the source driving voltage through some of other dummy channels among the plurality of dummy channels may be understood as the component receiving one or more source driving voltages through some of other dummy channels among the plurality of dummy channels (e.g., each of the some of the other dummy channels may receive a respective source driving voltage). A statement that a component receives the offset voltage through some of the plurality of dummy channels may be understood as the component receiving one or more offset voltages through some of the plurality of dummy channels (e.g., each of the some of the plurality of dummy channels may receive a respective offset voltage).

In one or more examples, a first reference voltage or the first reference voltage may include one or more first reference voltages, a second reference voltage or the second reference voltage may include one or more second reference voltages. In one or more examples, a first source driving voltage or the first source driving voltage may include one or more first source driving voltages, and a second source driving voltage or the second source driving voltage may include one or more second source driving voltages.

Various examples and aspects of the present disclosure are described below. These are provided as examples, and do not limit the scope of the present disclosure.

A display device according to the various example embodiments of the present disclosure may include a display panel comprising a pixel, the pixel having a light-emitting element configured to emit light, the pixel connected to a data line and a sensing line; and a display driver configured to supply a data voltage to the data line and receive a sensing signal from the sensing line, and the display driver may include a first switch configured to supply a reference voltage to the sensing line; a second switch configured to supply a low-potential voltage to the sensing line; a sampling-holding module comprising a third switch connected to the sensing line, an analog-to-digital converter connected to the third switch and outputting sensing data, and a holding capacitor configured to hold a voltage applied to an input terminal of the analog-to-digital converter; a fourth switch configured to supply the low-potential voltage to the analog-to-digital converter; and a fifth switch configured to supply a sensing reference voltage to the analog-to-digital converter, the sensing reference voltage setting the range of the reference voltage during the sensing process of the reference voltage.

In the display device according to the various example embodiments of the present disclosure, the display driver may include an output channel connected to the data line; a sensing channel connected to the sensing line; and a plurality of dummy channels configured to receive an offset voltage for adjusting the gain of the analog-to-digital converter, a source driving voltage driving the display driver, and the reference voltage.

In the display device according to the various example embodiments of the present disclosure, at least one dummy channel among the plurality of dummy channels may be directly connected to the third switch of the sampling-holding module.

The display device according to the various example embodiments of the present disclosure may further include a flexible film on which the display driver is mounted; a source circuit board electrically connected to the flexible film; a memory mounted on the source circuit board; a control circuit board electrically connected to the source circuit board; a timing controller mounted on the control circuit board to control the driving timing of the display driver; and a power supply unit mounted on the control circuit board to supply the reference voltage.

In the display device according to the various example embodiments of the present disclosure, the display driver may include a first display driver closest to the control circuit board; a second display driver adjacent to the first display driver; and a third display driver adjacent to the second display driver.

In the display device according to the various example embodiments of the present disclosure, each of the first to third display drivers may receive the reference voltage through some of the plurality of dummy channels, receive the source driving voltage through some of the other dummy channels, and receive the offset voltage through some of the other dummy channels.

In the display device according to the various example embodiments of the present disclosure, the first display driver may receive the reference voltage through some of dummy channels among the plurality of dummy channels, the second display driver may receive the source driving voltage through some of other dummy channels among the plurality of dummy channels, and the first to third display drivers may receive the offset voltage through some of the plurality of dummy channels.

In the display device according to the various example embodiments of the present disclosure, a power-on state for displaying an image, the power supply unit may output a first reference voltage, the display driver senses the first reference voltage, the timing controller may receive a second reference voltage stored in the memory, compare the first and second reference voltages, and transmit a correction value of the first reference voltage to the power supply unit.

In the display device according to the various example embodiments of the present disclosure, in a power-off state in which an image is not displayed, the power supply unit may output a first reference voltage, the display driver senses the first reference voltage, the timing controller may receive a second reference voltage stored in the memory, compare the first and second reference voltages, and store a correction value of the first reference voltage in the memory, and in a power-on state in which an image is displayed, the timing controller receives the correction value of the first reference voltage stored in the memory and transmits the correction value to the power supply unit.

In the display device according to the various example embodiments of the present disclosure, in a power-on state for displaying an image, the power supply unit may output a first source driving voltage, the display driver senses the first source driving voltage, the timing controller may receive a second source driving voltage stored in the memory, compare the first and second source driving voltages, and transmit a correction value of the first source driving voltage to the power supply unit.

In the display device according to the various example embodiments of the present disclosure, in a power-off state in which an image is not displayed, the power supply unit may output a first source driving voltage, the display driver may sense the first source driving voltage, the timing controller may receive a second source driving voltage stored in the memory, compare the first and second source driving voltages, and stores a correction value of the first source driving voltage in the memory, and in a power-on state in which an image is displayed, the timing controller may receive the correction value of the first source driving voltage stored in the memory and transmit it to the power supply unit.

In the display device according to the various example embodiments of the present disclosure, the analog-to-digital converter may repeatedly sense the reference voltage based on the low-potential voltage, and the timing controller may calculate a first average value of first sensed values, and the analog-to-digital converter may repeatedly sense the reference voltage based on the sensing reference voltage, and the timing controller may calculate a second average value of second sensed values, and the timing controller compares the first and second average values to calculate a correction value of the sensing reference voltage and transmits the correction value to the power supply unit.

In the display device according to the various example embodiments of the present disclosure, the pixel may comprise a first transistor configured to supply a driving voltage driving the pixel to the light-emitting element; a second transistor configured to electrically connect the data line and a gate electrode of the first transistor; and a third transistor configured to electrically connect the sensing line and a source electrode of the first transistor.

In the display device according to the various example embodiments of the present disclosure, the first switch may be turned on during the RT period for sensing the pixel to supply the reference voltage to the sensing line, and the second switch may be turned on during the OFF-RS period for adjusting the gain of the analog-to-digital converter to supply the low-potential voltage to the sensing line.

In another aspect, a display device according to the various example embodiments of the present disclosure may include a display panel comprising a pixel, the pixel having a light-emitting element configured to emit light, the pixel connected to a data line and a sensing line; a display driver including a sampling-holding module, the sampling-holding module configured to supply a data voltage to the data line and receive a sensing signal from the sensing line; a source circuit board electrically connected to the display driver; a memory mounted on the source circuit board; a control circuit board electrically connected to the source circuit board; and a timing controller mounted on the control circuit board, the timing controller configured to control a driving timing of the display driver, and the display driver may include an output channel connected to the data line; a sensing channel connected to the sensing line; and a plurality of dummy channels configured to receive an offset voltage for adjusting the gain of the analog-to-digital converter, a source driving voltage driving the display driver, and the reference voltage.

In the display device according to the various example embodiments of the present disclosure, the display driver may further include a first switch configured to supply a given reference voltage to the sensing line, and a second switch configured to supply a low-potential voltage to the sensing line, and the sampling-holding module may include a third switch connected to the sensing line; and an analog-to-digital converter connected to the third switch to output sensing data.

In the display device according to the various example embodiments of the present disclosure, the display driver may further comprise a fourth switch configured to supply the low-potential voltage to the analog-to-digital converter; and a fifth switch configured to supply a sensing reference voltage, which sets the range of the reference voltage during the sensing process of the reference voltage, to the analog-to-digital converter.

In the display device according to the various example embodiments of the present disclosure, the display driver may include a first display driver closest to the control circuit board; a second display driver adjacent to the first display driver; and a third display driver adjacent to the second display driver.

In the display device according to the various example embodiments of the present disclosure, each of the first to third display drivers may receive the reference voltage through some of the plurality of dummy channels, receive the source driving voltage through some of the other dummy channels, and receive the offset voltage through some of the other dummy channels.

In the display device according to the various example embodiments of the present disclosure, the first display driver may receive the reference voltage through some of dummy channels among the plurality of dummy channels, the second display driver may receive the source driving voltage through some of other dummy channels among the plurality of dummy channels, and the first to third display drivers may receive the offset voltage through some of the plurality of dummy channels.

A display device according to the various example embodiments of the present disclosure may include a display panel comprising a pixel, the pixel having a light-emitting element configured to emit light, the pixel connected to a data line and a sensing line; a display driver coupled to the display panel, the display driver configured to supply a data voltage to the data line and receive a sensing signal from the sensing line; a control circuit board coupled to the display driver, the control circuit board comprising a timing controller and a power supply unit, the timing controller configured to control a driving timing of the display driver, wherein at least one of the control circuit board, the timing controller, and the power supply unit is detachable and replaceable without replacing the display panel or the display driver, and wherein the timing controller is configured to correct a reference voltage based on a predetermined value, the reference voltage being used during a sensing process of the pixel.

In the display device according to the various example embodiments of the present disclosure, display device may include a memory coupled to the display driver, and the control circuit board is detachable and replaceable without replacing the display panel, the display driver, or the memory.

In the display device according to the various example embodiments of the present disclosure, the power supply unit is configured to output a first reference voltage, the display driver is configured to sense the first reference voltage, the timing controller is configured to receive a second reference voltage stored in the memory, compare the first and second reference voltages, and transmit a correction value of the first reference voltage to the power supply unit, and the power supply unit is configured to output a corrected first reference voltage.

In the display device according to the various example embodiments of the present disclosure, the reference voltage comprises the first reference voltage, and the predetermined value corresponds to the second reference voltage stored in the memory.

Although the present disclosure has been described with reference to the example drawings, it is to be understood that the present disclosure is not limited to the example embodiments and drawings disclosed in this disclosure, and those skilled in the art will appreciate that various modifications are possible without departing from the scope and spirit of the present disclosure. In addition to the various effects described herein, other effects may be realized by the disclosed configuration without departing from the scope of the present disclosure. The scope of the present disclosure is not limited to the embodiments shown, but is to be accorded the widest scope consistent with the claims and their equivalents.

What is claimed is:

1. A display device, comprising:
a display panel comprising a pixel, the pixel having a light-emitting element configured to emit light, the pixel connected to a data line and a sensing line; and
a display driver configured to supply a data voltage to the data line and receive a sensing signal from the sensing line,
wherein the display driver comprises:
a first switch configured to supply a reference voltage to the sensing line;
a second switch configured to supply a low-potential voltage to the sensing line;
a sampling-holding module comprising a third switch connected to the sensing line, an analog-to-digital converter connected to the third switch and for outputting sensing data, and a holding capacitor configured to hold a voltage applied to an input terminal of the analog-to-digital converter;
a fourth switch configured to supply the low-potential voltage to the analog-to-digital converter; and
a fifth switch configured to supply a sensing reference voltage to the analog-to-digital converter, the sensing reference voltage for setting a range of the reference voltage during a sensing process of the reference voltage.

2. The display device of claim 1, wherein the display driver comprises:
an output channel connected to the data line;
a sensing channel connected to the sensing line; and
a plurality of dummy channels configured to receive an offset voltage for adjusting a gain of the analog-to-digital converter, a source driving voltage driving the display driver, and the reference voltage.

3. The display device of claim 2, wherein at least one dummy channel among the plurality of dummy channels is directly connected to the third switch of the sampling-holding module.

4. The display device of claim 2, further comprising:
a flexible film on which the display driver is mounted;
a source circuit board electrically connected to the flexible film;
a memory mounted on the source circuit board;
a control circuit board electrically connected to the source circuit board;
a timing controller mounted on the control circuit board, the timing controller configured to control a driving timing of the display driver; and
a power supply unit mounted on the control circuit board to supply the reference voltage.

5. The display device of claim 4, wherein the display driver comprises:
a first display driver closest to the control circuit board;
a second display driver adjacent to the first display driver; and
a third display driver adjacent to the second display driver.

6. The display device of claim 5, wherein each of the first, second and the third display driver includes a plurality of dummy channels, and each of the first, second and third display drivers is configured to receive the reference voltage through a part of dummy channels among the plurality of dummy channels, receive the source driving voltage through another part of dummy channels among the plurality of dummy channels, and receive the offset voltage through a remaining part of dummy channels among the plurality of dummy channels.

7. The display device of claim 5, wherein each of the first, second and the third display driver includes a plurality of dummy channels, and the first display driver is configured to receive the reference voltage through a part of dummy channels among the plurality of dummy channels and receive the offset voltage through a remaining part of dummy channels among the plurality of dummy channels, the second display driver is configured to receive the source driving voltage through a part of dummy channels among the plurality of dummy channels and receive the offset voltage through a remaining part of dummy channels among the plurality of dummy channels, and the third display driver is configured to receive the offset voltage through the plurality of dummy channels.

8. The display device of claim 4, wherein in a power-on state for displaying an image, the power supply unit is configured to output a first reference voltage, the display driver is configured to sense the first reference voltage, and the timing controller is configured to receive a second reference voltage stored in the memory, compare the first and second reference voltages to calculate a correction value of the first reference voltage, and transmit the correction value of the first reference voltage to the power supply unit.

9. The display device of claim 4, wherein in a power-off state in which an image is not displayed, the power supply unit is configured to output a first reference voltage, the display driver is configured to sense the first reference voltage, and the timing controller is configured to receive a second reference voltage stored in the memory, compare the first and second reference voltages to calculate a correction value of the first reference voltage, and store the correction value of the first reference voltage in the memory, and
wherein in a power-on state in which an image is displayed, the timing controller is configured to receive the correction value of the first reference voltage stored in the memory and transmit the correction value to the power supply unit.

10. The display device of claim 4, wherein in a power-on state for displaying an image, the power supply unit is configured to output a first source driving voltage, the display driver is configured to sense the first source driving voltage, and the timing controller is configured to receive a second source driving voltage stored in the memory, compare the first and second source driving voltages to calculate a correction value of the first source driving voltage, and transmit a correction value of the first source driving voltage to the power supply unit.

11. The display device of claim 4, wherein in a power-off state in which an image is not displayed, the power supply unit is configured to output a first source driving voltage, the display driver is configured to sense the first source driving voltage, the timing controller is configured to receive a second source driving voltage stored in the memory, compare the first and second source driving voltages to calculate a correction value of the first source driving voltage, and store the correction value of the first source driving voltage in the memory, and
wherein in a power-on state in which an image is displayed, the timing controller is configured to receive the correction value of the first source driving voltage stored in the memory and transmit the correction value to the power supply unit.

12. The display device of claim 4, wherein the analog-to-digital converter is configured to repeatedly sense the reference voltage based on the low-potential voltage, and the timing controller is configured to calculate a first average value of sensed values,
wherein the analog-to-digital converter is configured to repeatedly sense the reference voltage based on the sensing reference voltage, and the timing controller is configured to calculate a second average value of sensed values, and
wherein the timing controller is configured to compare the first and second average values to calculate a correction value of the sensing reference voltage and transmit the correction value of the sensing reference voltage to the power supply unit.

13. The display device of claim 1, wherein the pixel comprises:
a first transistor configured to supply a driving voltage driving the pixel to the light-emitting element;
a second transistor configured to electrically connect the data line and a gate electrode of the first transistor; and
a third transistor configured to electrically connect the sensing line and a source electrode of the first transistor.

14. The display device of claim 13, wherein the first switch is turned on during a real time sensing(RT) period for sensing the pixel to supply the reference voltage to the sensing line, and
wherein the second switch is turned on during an off-state real time sensing (OFF-RS) period for adjusting a gain of the analog-to-digital converter to supply the low-potential voltage to the sensing line.

15. A display device, comprising:
a display panel comprising a pixel, the pixel having a light-emitting element configured to emit light, the pixel connected to a data line and a sensing line;
a display driver including a sampling-holding module, the sampling-holding module configured to supply a data voltage to the data line and receive a sensing signal from the sensing line;
a source circuit board electrically connected to the display driver;
a memory mounted on the source circuit board;
a control circuit board electrically connected to the source circuit board; and
a timing controller mounted on the control circuit board, the timing controller configured to control a driving timing of the display driver,
wherein the display driver comprises:
an output channel connected to the data line;
a sensing channel connected to the sensing line; and
a plurality of dummy channels configured to receive an offset voltage for adjusting a gain of an analog-to-digital converter of the sampling-holding module, a source driving voltage driving the display driver, and a reference voltage.

16. The display device of claim 15, wherein the display driver further comprises:
a first switch configured to supply the reference voltage to the sensing line; and
a second switch configured to supply a low-potential voltage to the sensing line, and
wherein the sampling-holding module comprises:
a third switch connected to the sensing line; and
the analog-to-digital converter connected to the third switch and for outputting sensing data.

17. The display device of claim 16, wherein the display driver further comprises:
a fourth switch configured to supply the low-potential voltage to the analog-to-digital converter; and
a fifth switch configured to supply a sensing reference voltage to the analog-to-digital converter, the sensing reference voltage for setting a range of the reference voltage during a sensing process of the reference voltage.

18. The display device of claim 16, wherein the display driver comprises:
a first display driver closest to the control circuit board;
a second display driver adjacent to the first display driver; and
a third display driver adjacent to the second display driver.

19. The display device of claim 18, wherein each of the first, second and the third display driver includes a plurality of dummy channels, and each of the first, second and third display drivers is configured to receive the reference voltage through a part of dummy channels among the plurality of dummy channels, receive the source driving voltage through another part of dummy channels among the plurality of dummy channels, and receive the offset voltage through a remaining part of dummy channels among the plurality of dummy channels.

20. The display device of claim 18, each of the first, second and the third display driver includes a plurality of dummy channels, and the first display driver is configured to receive the reference voltage through a part of dummy channels among the plurality of dummy channels and receive the offset voltage through a remaining part of dummy channels among the plurality of dummy channels, the second display driver is configured to receive the source driving voltage through a part of dummy channels among the plurality of dummy channels and receive the offset voltage through a remaining part of dummy channels among the plurality of dummy channels, and the third display driver is configured to receive the offset voltage through the plurality of dummy channels.
